(19) United States
(12) Patent Application Publication
(10) Pub. No.: US 2026/0029697 A1
(43) Pub. Date: Jan. 29, 2026

(54) OPTICAL SYSTEM, IMAGE PROJECTION APPARATUS, AND IMAGING APPARATUS

(71) Applicant: Panasonic Intellectual Property Management Co., Ltd., Osaka (JP)

(72) Inventor: Takuya IMAOKA, Kanagawa (JP)

(21) Appl. No.: 19/350,322

(22) Filed: Oct. 6, 2025

Related U.S. Application Data
(63) Continuation of application No. PCT/JP2024/015387, filed on Apr. 18, 2024.

(30) Foreign Application Priority Data
Jun. 13, 2023 (JP) 2023-097041

(51) Int. Cl. G03B 21/14; G02B 7/14; G02B 7/18; G02B 13/16; G02B 13/18; G02B 17/04; G03B 21/28

(52) U.S. Cl. CPC G03B 21/142; G02B 7/14; G02B 7/1805; G02B 13/16; G02B 13/18; G02B 17/04; G03B 21/28

(57) ABSTRACT

An optical system includes: a base optical system configured to allow either a first attachment optical system or a second optical system to be attached at a position closer to a magnification side than the base optical system. The first attachment optical system includes a first reflection surface group, and has a first optical characteristic. The second attachment optical system includes a second reflection surface group, and has a second optical characteristic. In a case where the first attachment optical system is attached to the base optical system, a vertical distance from an optical axis to the magnification conjugate point in a vertical direction to the magnification conjugate point perpendicular to the optical axis is set to a first shift amount. In a case where the second attachment optical system is attached to the base optical system, the vertical distance is set to a second shift amount.

### CROSS REFERENCE TO RELATED APPLICATION

This application claims benefit of priority to International Application No. PCT/JP2024/015387, with an international filing date of Apr. 18, 2024, which claims priority of Japanese Patent Application No. 2023-097041 filed on Jun. 13, 2023, the entire content of which is incorporated herein by reference.

### BACKGROUND

### Technical Field

The present disclosure relates to an optical system using a prism. The present disclosure also relates to an image projection apparatus and an imaging apparatus using such an optical system.

### Background Art

In JP 2022-156601 A and JP 2022-156602 A, an attachment optical system is detachably attached to a magnification side of a projection optical system 3 of a projector, and projection is performed on an image plane (for example, a dome-shaped screen, an oblique wide-angle screen) different from the projection optical system.

### SUMMARY

The present disclosure provides an optical system capable of performing a short-focus and large screen projection or imaging in an oblique direction, and capable of variably setting a shift amount of a projection range or an imaging range from an optical axis. The present disclosure also provides an image projection apparatus and an imaging apparatus using such an optical system.

An aspect of the present disclosure is an optical system having a reduction conjugate point on a reduction side and a magnification conjugate point on a magnification side, the optical system comprising:
a base optical system having a plurality of lenses rotationally symmetric with respect to an optical axis and an aperture stop;
a first attachment optical system including a first reflection surface group, and having a first optical characteristic; and
a second attachment optical system including a second reflection surface group, and having a second optical characteristic different from the first optical characteristic, wherein
the base optical system is configured to allow either a first attachment optical system or a second optical system to be attached at a position closer to a magnification side than the base optical system,
in a case where the first attachment optical system is attached to the base optical system, a vertical distance from the optical axis to the magnification conjugate point in a vertical direction to the magnification conjugate point perpendicular to the optical axis is set to a first shift amount, and
in a case where the second attachment optical system is attached to the base optical system, the vertical distance is set to a second shift amount different from the first shift amount.

Another aspect of the present disclosure is an image projection apparatus comprising: the optical system; and an image forming element configured to generate an image to be projected onto a screen via the optical system.

Another aspect of the present disclosure is an imaging apparatus comprising: the optical system; and an imaging element configured to receive an optical image formed by the optical system and convert the optical image into an electrical image signal.

According to an optical system according to the present disclosure, a shift amount of the projection range or the imaging range from an optical axis can variably be set by replacing an attachment optical system.

### BRIEF DESCRIPTION OF DRAWINGS

FIG. 1A is a side view illustrating configuration of an optical system according to the present disclosure;

FIG. 1B is a side view illustrating configuration of an optical system according to the present disclosure;

FIG. 1C is a side view illustrating configuration of an optical system according to the present disclosure;

FIG. 1D is atop view illustrating configuration of an optical system according to the present disclosure;

FIG. 1E is a top view illustrating configuration of an optical system according to the present disclosure;

FIG. 1F is a top view illustrating configuration of an optical system according to the present disclosure;

FIG. 2 is an arrangement diagram illustrating an optical system 1 according to a first example;

FIG. 3A is a perspective view illustrating a three-dimensional shape of each optical surface of a prism PM;

FIG. 3B illustrates a part of a light ray traveling inside the prism PM;

FIG. 4A is a cross-sectional view of the prism PM along a YZ plane;

FIG. 4B illustrates a part of the light ray traveling inside the prism PM;

FIG. 5A is a top view of the prism PM viewed from the Y direction;

FIG. 5B illustrates a part of the light ray traveling inside the prism PM;

FIG. 6A is a YZ cross-sectional view for explaining definitions of a first point on a first transmission surface T1, a second point on a second reflection surface R2, and an incident angle of a light ray on the second reflection surface R2;

FIG. 6B is a YZ cross-sectional view for explaining the definitions of distances PL1 and PL2;

FIG. 7 is a lateral aberration diagram of the optical system 1 including a first attachment optical system 11 according to the first example;

FIG. 8 is a lateral aberration diagram of the optical system 1 including a second attachment optical system 12 according to the first example;

FIG. 9 is a lateral aberration diagram of the optical system 1 including a third attachment optical system 13 according to the first example;

FIG. 10 is an arrangement diagram illustrating the optical system 1 according to a second example;

FIG. 11 is a lateral aberration diagram of the optical system 1 including the first attachment optical system 11 according to the second example;

FIG. 12 is a lateral aberration diagram of the optical system 1 including the second attachment optical system 12 according to the second example;

FIG. 13 is a lateral aberration diagram of the optical system 1 including the third attachment optical system 13 according to the second example;

FIG. 14A illustrates a state where an image projection apparatus 100 is installed on the lower surface of a ceiling CE;

FIG. 14B illustrates a state where the image projection apparatus 100 is installed on the upper surface of the ceiling CE;

FIG. 15A is a YZ cross-sectional view for explaining definitions of variables in formula (1);

FIG. 15B is a ZX cross-sectional view for explaining definitions of variables in formula (1);

FIG. 16A is an explanatory view illustrating a relationship between a vertical position of an image forming element and a vertical position of an effective area on which a total light ray is projected on a screen;

FIG. 16B is an explanatory view illustrating a relationship between a vertical position of an image forming element and a vertical position of an effective area on which a total light ray is projected on a screen;

FIG. 16C is an explanatory view illustrating a relationship between a vertical position of an image forming element and a vertical position of an effective area on which a total light ray is projected on a screen;

FIG. 16D is an explanatory view illustrating a relationship between a vertical position of an image forming element and a vertical position of an effective area on which a total light ray is projected on a screen;

FIG. 16E is an explanatory view illustrating a relationship between a vertical position of an image forming element and a vertical position of an effective area on which a total light ray is projected on a screen;

FIG. 17 is a block diagram illustrating an example of an image projection apparatus according to the present disclosure; and

FIG. 18 is a block diagram illustrating an example of an imaging apparatus according to the present disclosure.

### DETAILED DESCRIPTION

Hereinafter, embodiments will be described in detail with reference to the drawings as appropriate. However, unnecessarily detailed description may be omitted. For example, a detailed description of a well-known matter or a repeated description of substantially the same configuration may be omitted. This is to avoid unnecessary redundancy of the following description and to facilitate understanding of those skilled in the art.

Note that, the applicant provides the accompanying drawings and the following description for those skilled in the art to fully understand the present disclosure, and does not intend to limit the subject matter described in the claims by the accompanying drawings and the following description.

Hereinafter, each example of the optical system according to the present disclosure will be described. In each example, a case where the optical system is used for a projector (an example of an image projection apparatus) that projects image light of an original image SA obtained by spatially modulating incident light by an image forming element such as a liquid crystal or a digital micromirror device (DMD) based on an image signal onto a screen will be described. That is, the optical system according to the present disclosure can be used to dispose a screen (not illustrated) on the extension line on the magnification side, magnify the original image SA on the image forming element disposed on the reduction side, and project the magnified original image SA onto the screen. However, a surface to be projected is not limited to the screen. The surface to be projected also includes a wall, a ceiling, a floor, a window, and the like of a house, a store, a vehicle, or inside an airplane used as a mobile transportation means.

In addition, the optical system according to the present disclosure can also be used to collect light emitted from an object located on an extension line on the magnification side and form an optical image of the object on an imaging surface of an imaging element disposed on the reduction side.

### First Embodiment

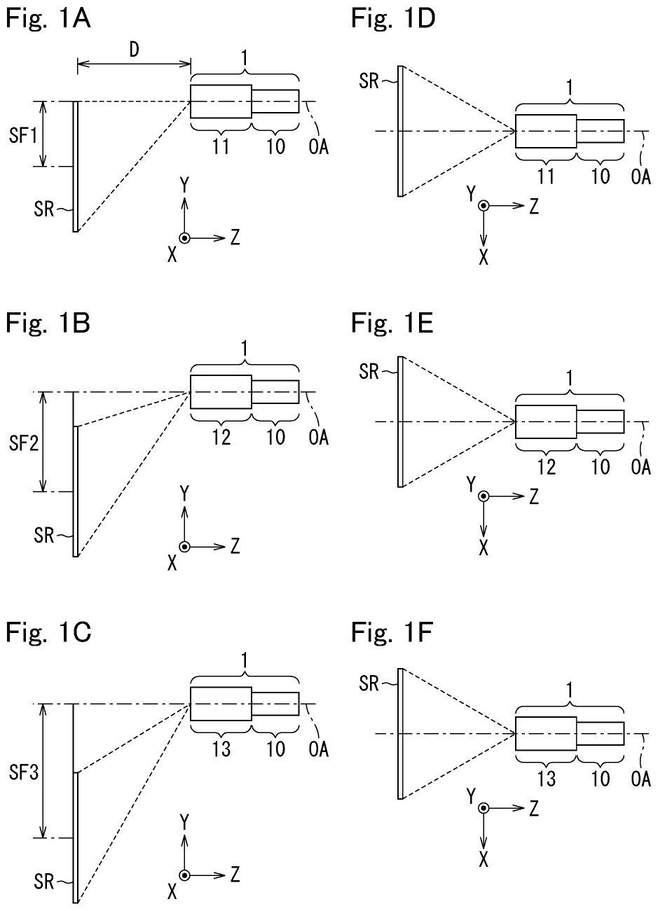

An optical system according to a first embodiment of the present disclosure will be described below with reference to FIGS. 1A to 15B. FIGS. 1A to 1C are side views illustrating various configurations of an optical system according to the present disclosure, and FIGS. 1D to 1F are top views thereof.

The optical system 1 includes a base optical system 10, and a first attachment optical system 11, a second attachment optical system 12, and a third attachment optical system 13 which are exchangeably attached to the base optical system 10. Here, the three attachment optical systems are exemplified, but two or four or more attachment optical systems can also be used.

In FIGS. 1A to 1F, a reduction conjugate point which is an image forming position on the reduction side is located on the right side, and a magnification conjugate point which is an image forming position on the magnification side is located on the left side. The first to third attachment optical systems 11 to 13 are disposed closer to the magnification side than the base optical system 10, and are detachably attached to the base optical system 10 in accordance with various lens mount standards.

In a case where the optical system 1 is used in the image projection apparatus, an effective area on which the total light ray is projected is set on a screen SR, and a shift amount SF from an optical axis OA of the optical system 1 to the center of the vertical range of the effective area can be defined.

As illustrated in FIG. 1A, in a case where the first attachment optical system 11 is attached to the base optical system 10, a shift amount SF1 is set. As illustrated in FIG. 1B, in a case where the second attachment optical system 12 is attached to the base optical system 10, a shift amount SF2 larger than the shift amount SF1 is set. As illustrated in FIG. 1C, in a case where the third attachment optical system 13 is attached to the base optical system 10, a shift amount SF3 larger than the shift amount SF2 is set. Therefore, the base optical system 10 is the same optical system, but the first to third attachment optical systems 11 to 13 use different optical designs respectively.

In addition, as illustrated in FIGS. 1D to 1F, a half angle of view of the light projected from the optical system 1 in the horizontal direction can be set to, for example, 2 degrees or less so as to be small.

### First Example

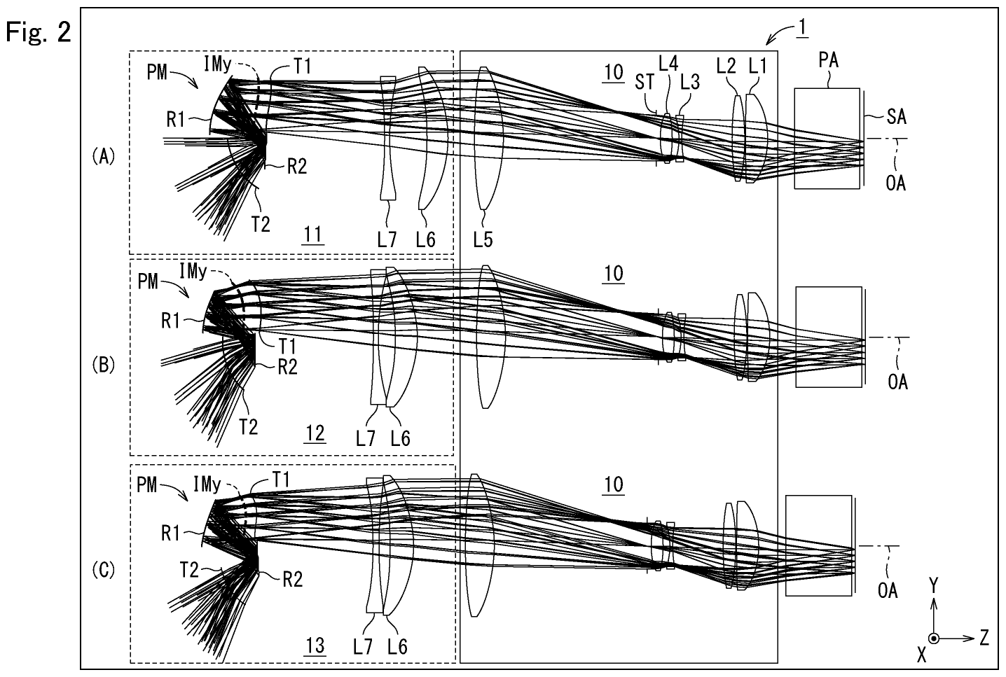

FIG. 2 is an arrangement diagram illustrating the optical system 1 according to a first example. The optical system 1 includes the base optical system 10 including a plurality of lenses and an aperture stop ST, and the first to third attachment optical systems 11 to 13 including a plurality of lenses and the prism PM. In FIG. 2, the reduction conjugate point, which is the image forming position on the reduction side, is located on the right side of the optical axis OA, and the magnification conjugate point, which is the image forming position on the magnification side, is located on the lower left side of the optical axis OA.

Inside the optical system 1, an intermediate imaging position that is conjugate with each of the reduction conjugate point and the magnification conjugate point is located. In this intermediate imaging position, both a Y-direction intermediate image IMy and an X-direction intermediate image IMx exist inside the prism PM. The Y-direction intermediate image IMy is illustrated in FIG. 2, but the X-direction intermediate image IMx is not illustrated.

The base optical system 10 includes an optical element PA and lens elements L1 to L5 in order from the reduction side to the magnification side. The optical element PA represents an optical element such as a total internal reflection (TIR) prism, a prism for color separation and color synthesis, an optical filter, a parallel flat plate glass, a crystal low-pass filter, and an infrared cut filter. The reduction conjugate point is set at a position at a predetermined distance from the end surface on the reduction side of the optical element PA, and the original image SA is installed therein (surface 23). Regarding the surface number, a numerical example to be described later will be referred to.

The optical element PA has two parallel and flat transmission surfaces (surfaces 21 and 22). The lens element L1 has a biconvex shape (surfaces 19 and 20). The lens element L2 has a biconvex shape (surfaces 17 and 18). The lens element L3 has a biconcave shape (surfaces 15 and 16). The lens element L4 has a biconvex shape (surfaces 13 and 14). The lens element L5 has a biconvex shape (surfaces 9 and 10). These lens elements L1 to L5 are rotationally symmetric lenses having a rotationally symmetric surface shape around the optical axis OA of the base optical system 10, and portions through which light rays do not pass may be deleted as necessary.

The aperture stop ST defines a range in which the light flux passes through the optical system 1, and is positioned between the reduction conjugate point and the above-described intermediate imaging position. As an example, the aperture stop ST (surface 12) is located between the lens element L4 and the lens element L5.

The first to third attachment optical systems 11 to 13 include lens elements L6 to L7 and the prism PM. The lens elements L6 to L7 are rotationally symmetric lenses having a rotationally symmetric surface shape around the optical axis OA, and portions through which light rays do not pass may be deleted as necessary. The lens element L6 has a positive meniscus shape with a convex surface facing the reduction side (surfaces 7 and 8). The lens element L7 has a biconcave shape (surfaces 5 and 6).

The prism PM is formed of a transparent medium, for example, glass, synthetic resin, or the like. The prism PM includes, as a plurality of optical surfaces, a first transmission surface T1 located on the reduction side, a second transmission surface T2 located on the magnification side, and two reflection surfaces of a first reflection surfaces R1 and a second reflection surface R2 located on the optical path between the first transmission surface T1 and the second transmission surface T2. The first transmission surface T1 has a free-form surface shape with a convex surface facing the reduction side (surface 4). The first reflection surface R1 has a free-form surface shape with a concave surface (main curvature) facing in a direction in which a light ray incident on the first reflection surface R1 is reflected (surface 3). The second reflection surface R2 has a free-form surface shape with a concave surface (main curvature) oriented in a direction in which the light ray incident on the second reflection surface R2 is reflected (surface 2). The second transmission surface T2 has a free-form surface shape with a convex surface facing the magnification side (surface 1).

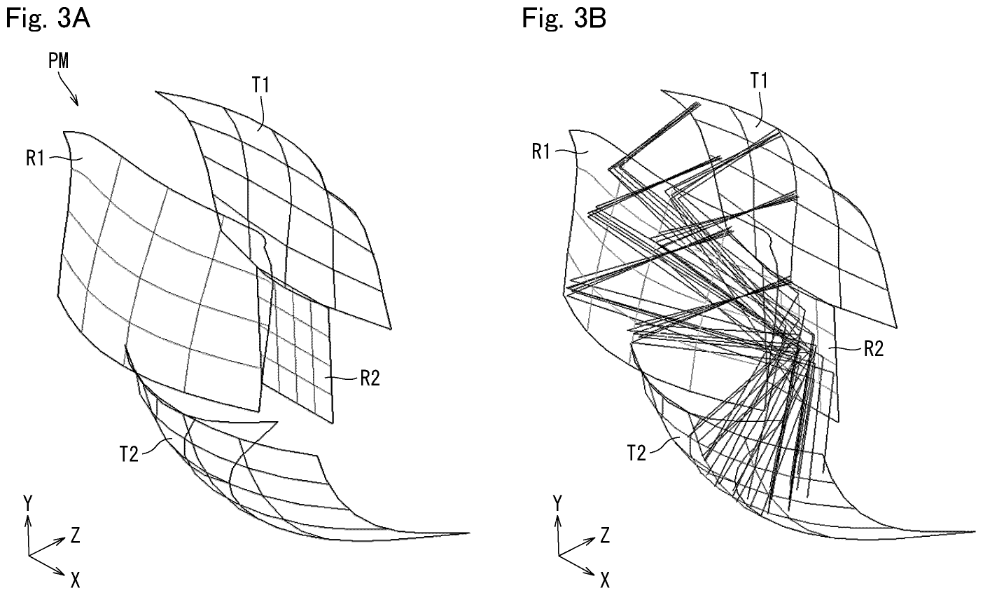

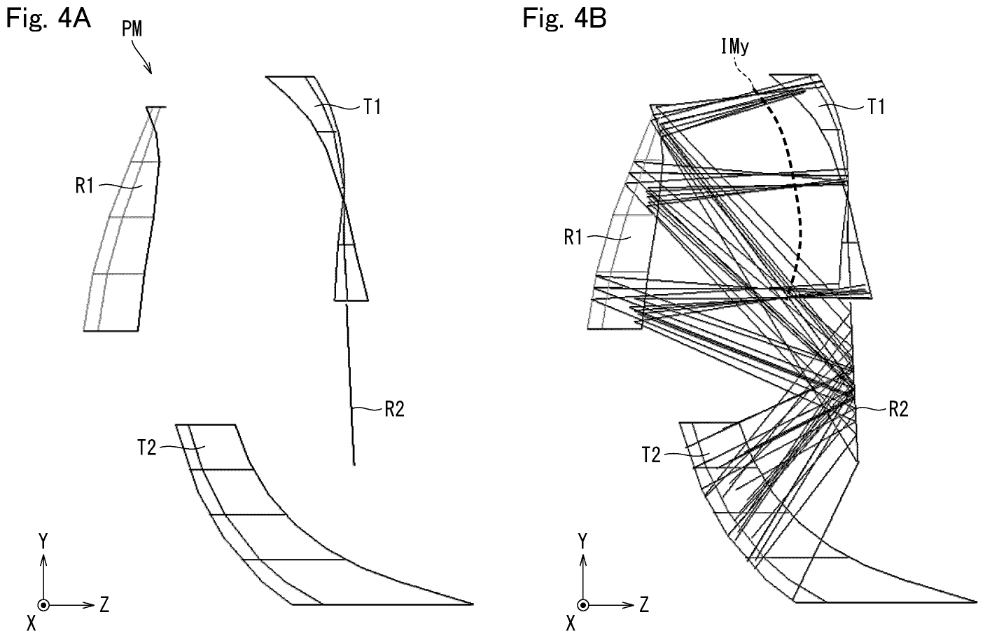

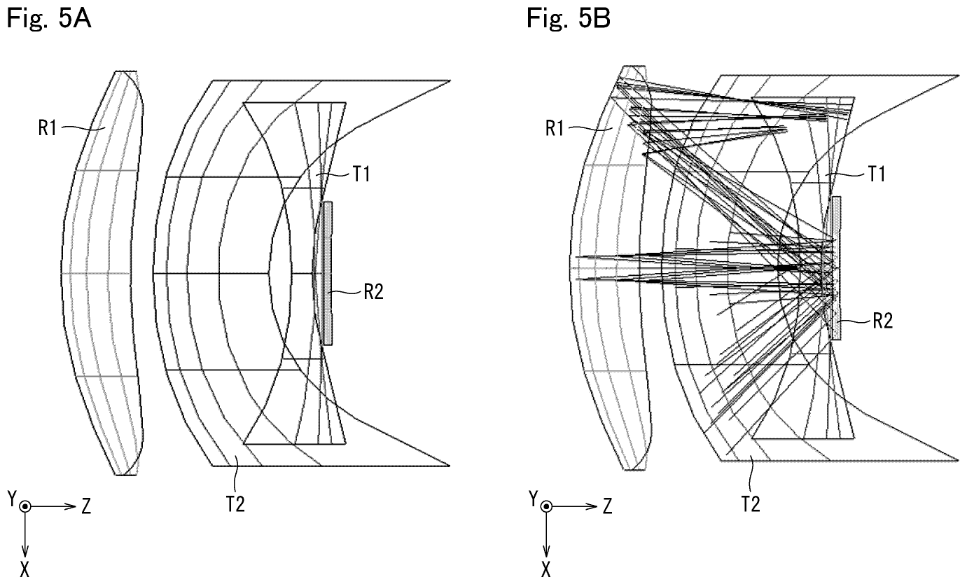

FIG. 3A is a perspective view illustrating a three-dimensional shape of each optical surface of the prism PM, and FIG. 3B illustrates a part of light rays traveling inside the prism PM. FIG. 4A is a cross-sectional view of the prism PM along the YZ plane, and FIG. 4B illustrates a part of the light rays traveling inside the prism PM. FIG. 5A is a top view of the prism PM viewed from the Y direction, and FIG. 5B illustrates a part of the light rays traveling inside the prism PM.

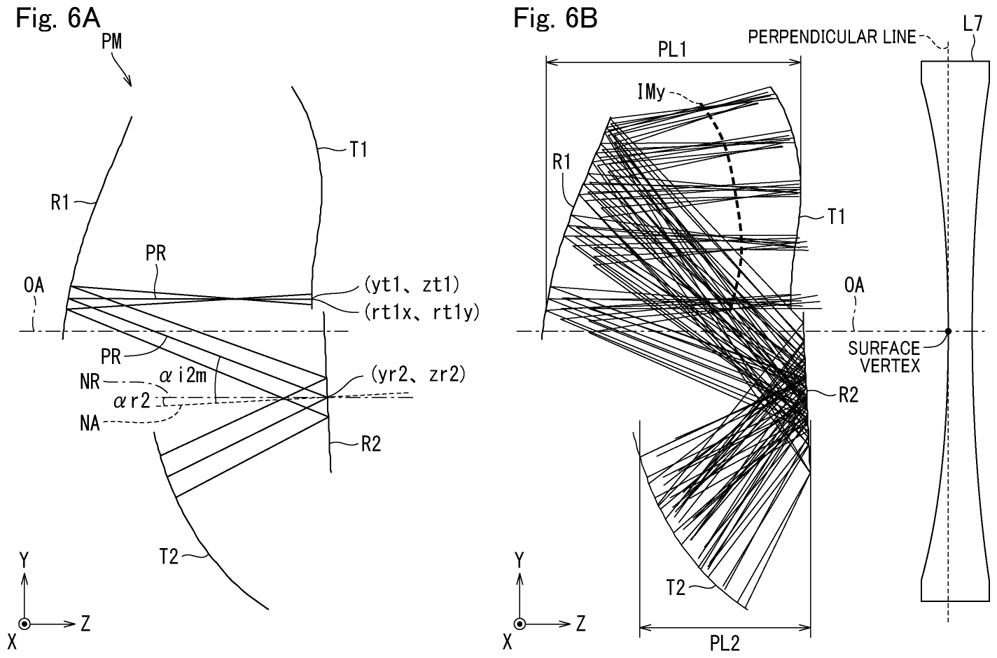

FIG. 6A is a YZ cross-sectional view for explaining definitions of a first point on the first transmission surface T1, a second point on the second reflection surface R2, and an incident angle of a light ray on the second reflection surface R2. FIG. 6B is a YZ cross-sectional view for explaining the definitions of distances PL1 and PL2. Details will be described later.

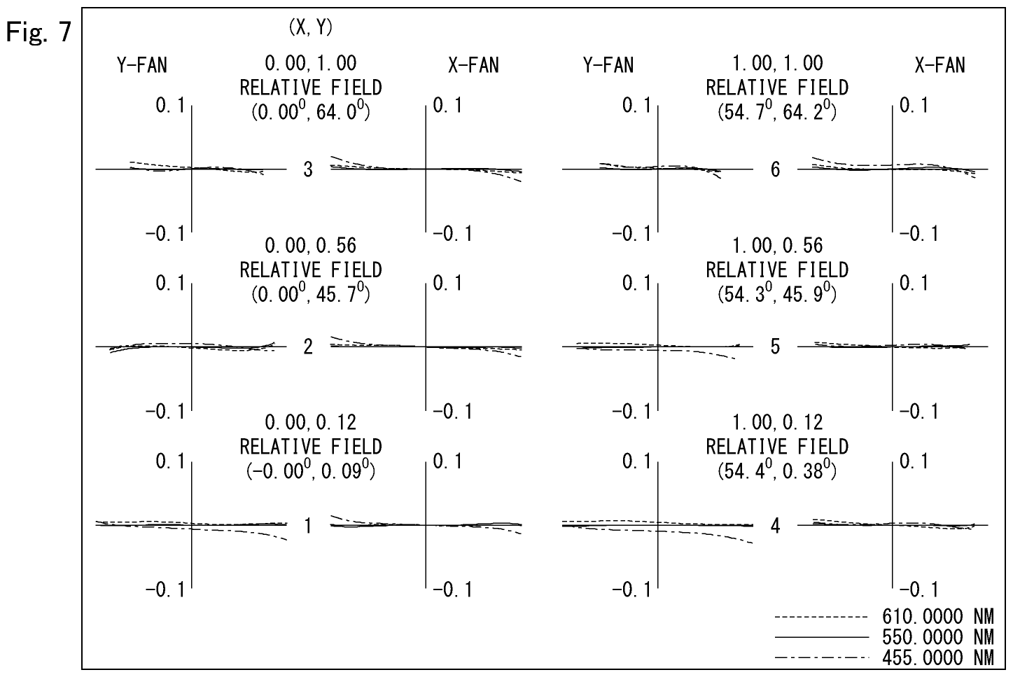

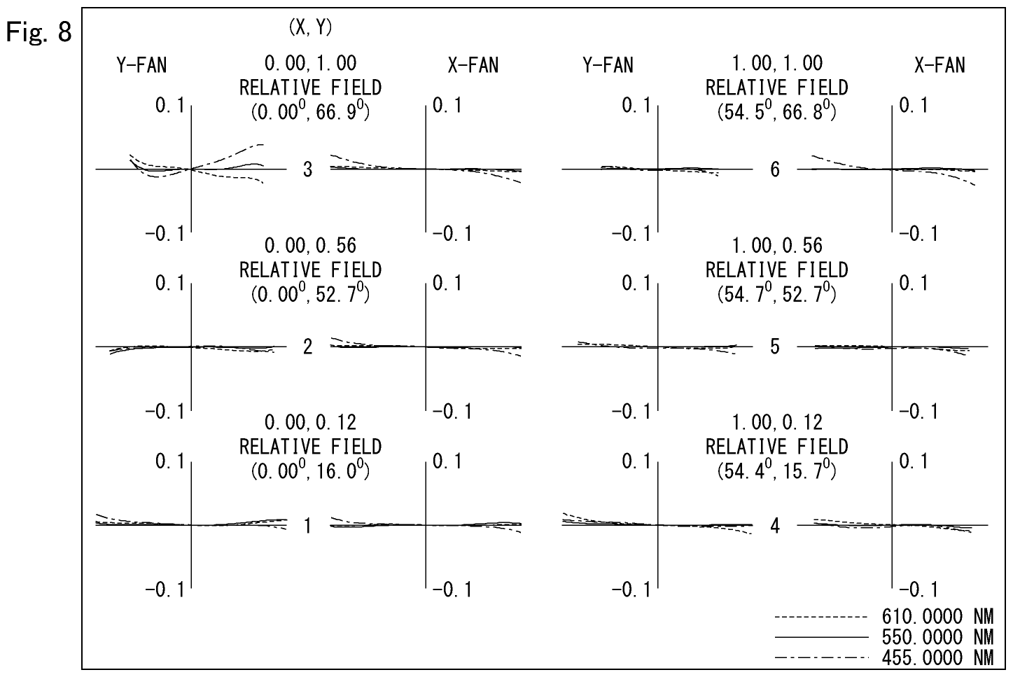

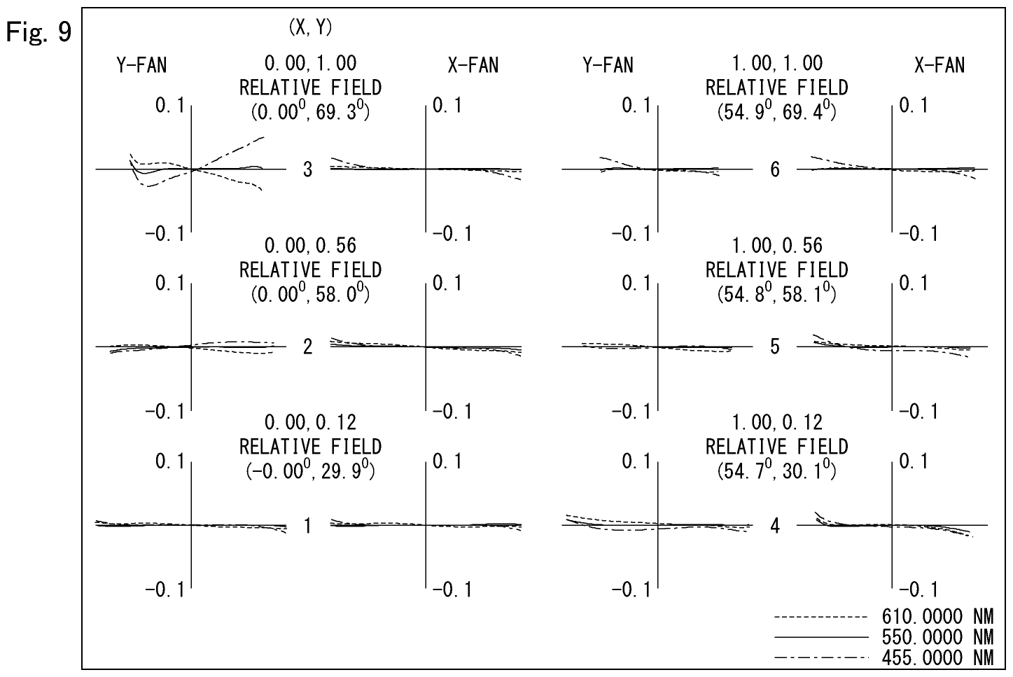

FIG. 7 is a lateral aberration diagram of the optical system 1 including the first attachment optical system 11 according to the first example. FIG. 8 is a lateral aberration diagram of the optical system 1 including the second attachment optical system 12 according to the first example. FIG. 9 is a lateral aberration diagram of the optical system 1 including the third attachment optical system 13 according to the first example. Each graph corresponds to normalized coordinates (X, Y)=(1.00,1.00), (1.00,0.56), (1.00,0.12), (0.00,1.00), (0.00,0.56), and (0.00,0.12) of the first rectangular effective area at the reduction conjugate point. The solid line indicates a wavelength of 550.0000 nm, the broken line indicates a wavelength of 610.0000 nm, and the alternate long and short dash line indicates a wavelength of 455.0000 nm. From these graphs, it can be seen that the optical system 1 according to the first example exhibits excellent optical performance.

### Second Example

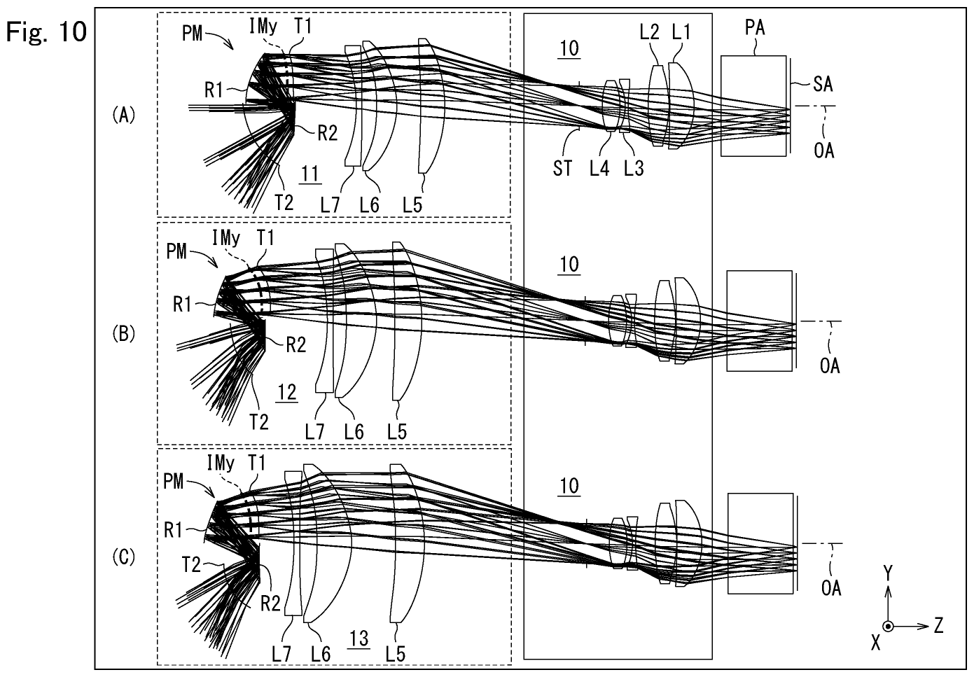

FIG. 10 is an arrangement diagram illustrating an optical system 1 according to a second example. The optical system 1 includes the base optical system 10 including a plurality of lenses and an aperture stop ST, and the first to third attachment optical systems 11 to 13 including a plurality of lenses and the prism PM. In FIG. 10, the reduction conjugate point, which is the image forming position on the reduction side, is located on the right side of the optical axis OA, and the magnification conjugate point, which is the image forming position on the magnification side, is located on the lower left side of the optical axis OA.

Inside the optical system 1, an intermediate imaging position that is conjugate with each of the reduction conjugate point and the magnification conjugate point is located. In this intermediate imaging position, both a Y-direction intermediate image IMy and an X-direction intermediate image IMx exist inside the prism PM. The Y-direction intermediate image IMy is illustrated in FIG. 2, but the X-direction intermediate image IMx is not illustrated.

The base optical system 10 includes an optical element PA and lens elements L1 to L4 in order from the reduction side to the magnification side. The reduction conjugate point is set at a position at a predetermined distance from the end surface on the reduction side of the optical element PA, and the original image SA is installed therein (surface 23). Regarding the surface number, a numerical example to be described later will be referred to.

The optical element PA has two parallel and flat transmission surfaces (surfaces 21 and 22). The lens element L1 has a positive meniscus shape with a convex surface facing the reduction side (surfaces 19 and 20). The lens element L2 has a biconvex shape (surfaces 17 and 18). The lens element L3 has a biconcave shape (surfaces 15 and 16). The lens element L4 has a biconvex shape (surfaces 13 and 14). These lens elements L1 to L4 are rotationally symmetric lenses having a surface shape rotationally symmetric around the optical axis OA of the base optical system 10, and portions through which light rays do not pass may be deleted as necessary.

The first to third attachment optical systems 11 to 13 include lens elements L5 to L7 and the prism PM. The lens elements L5 to L7 are rotationally symmetric lenses having a surface shape rotationally symmetric around the optical axis OA, and portions through which light rays do not pass may be deleted as necessary. The lens element L5 has a positive meniscus shape with a convex surface facing the reduction side (surfaces 9 and 10). The lens element L6 has a positive meniscus shape with a convex surface facing the reduction side (surfaces 7 and 8). The lens element L7 has a biconcave shape (surfaces 5 and 6).

The prism PM includes, as a plurality of optical surfaces, a first transmission surface T1 located on the reduction side, a second transmission surface T2 located on the magnification side, and two reflection surfaces of a first reflection surfaces R1 and a second reflection surface R2 located on the optical path between the first transmission surface T1 and the second transmission surface T2. The first transmission surface T1 has a free-form surface shape with a convex surface facing the reduction side (surface 4). The first reflection surface R1 has a free-form surface shape with a concave surface (main curvature) facing in a direction in which a light ray incident on the first reflection surface R1 is reflected (surface 3). The second reflection surface R2 has a free-form surface shape with a convex surface (main curvature) facing in a direction in which a light ray incident on the second reflection surface R2 is reflected (surface 2). The second transmission surface T2 has a free-form surface shape with a convex surface facing the magnification side (surface 1).

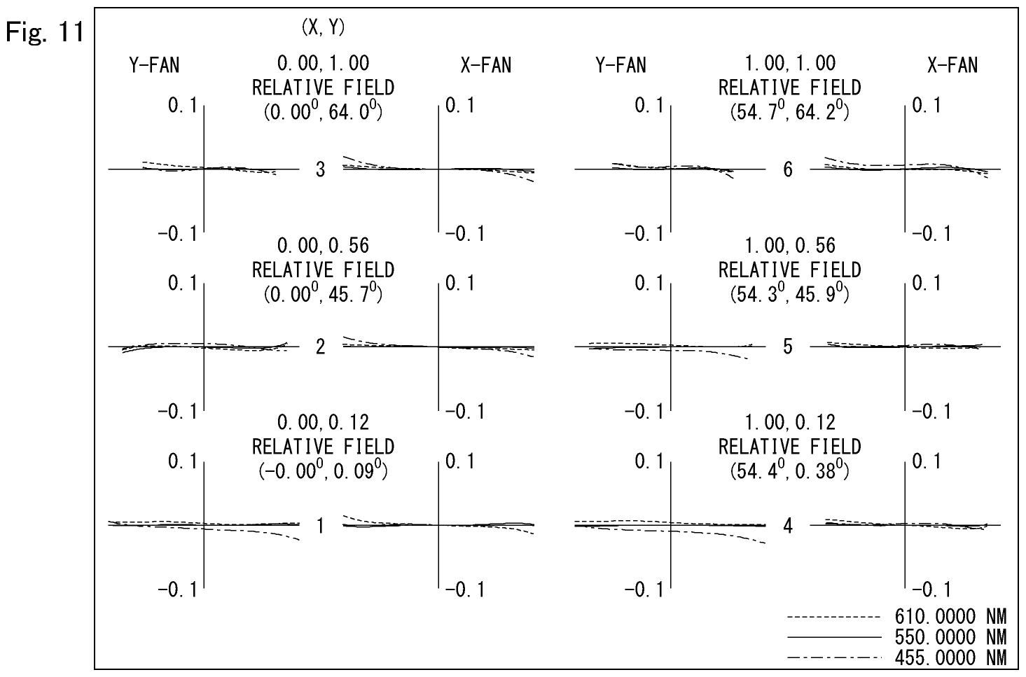

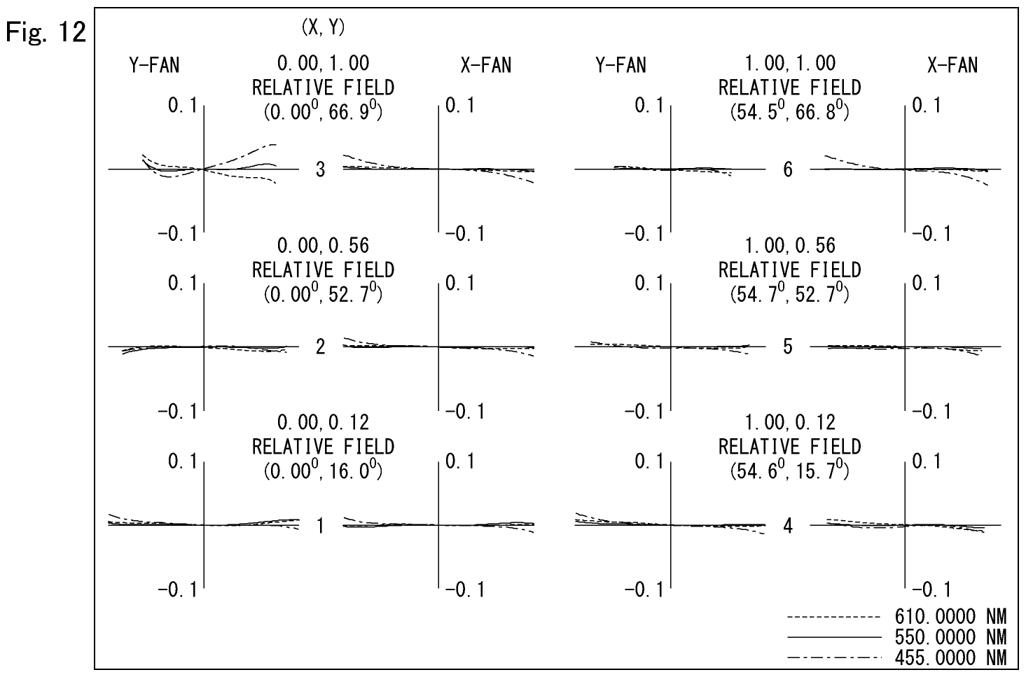

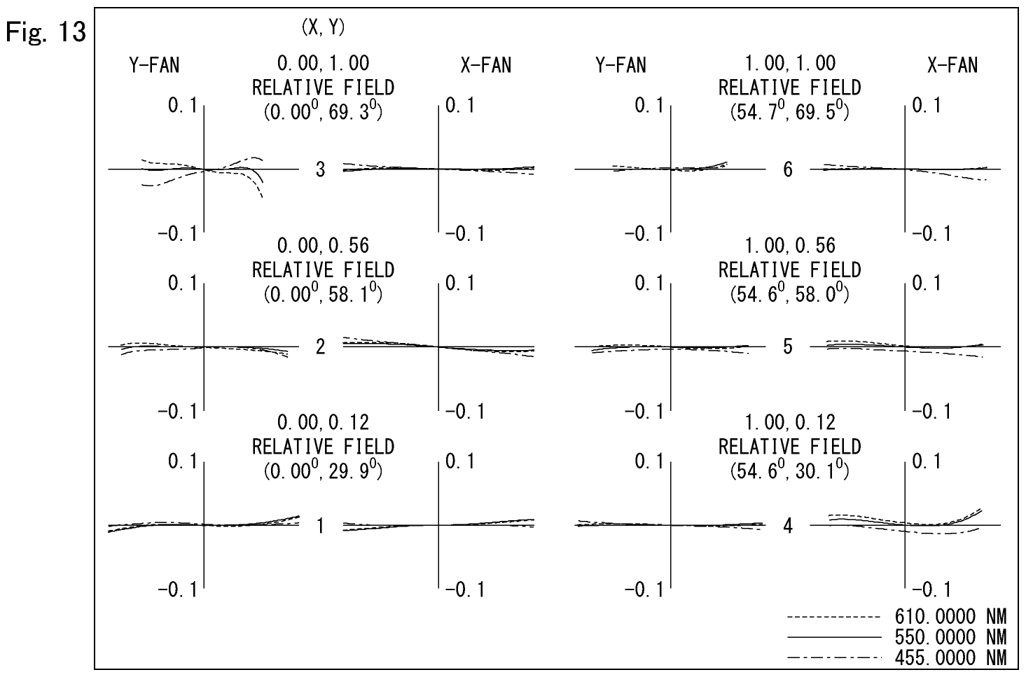

FIG. 11 is a lateral aberration diagram of the optical system 1 including the first attachment optical system 11 according to the second example. FIG. 12 is a lateral aberration diagram of the optical system 1 including the second attachment optical system 12 according to the second example. FIG. 13 is a lateral aberration diagram of the optical system 1 including the third attachment optical system 13 according to the second example. Each graph corresponds to normalized coordinates (X, Y)=(1.00,1.00), (1.00,0.56), (1.00,0.12), (0.00,1.00), (0.00,0.56), and (0.00,0.12) of the first rectangular effective area at the reduction conjugate point. From these graphs, it can be seen that the optical system 1 according to the second example exhibits excellent optical performance.

Next, conditions that can be satisfied by the optical system according to the present embodiment will be described. Note that, although a plurality of conditions is defined for the optical system according to each example, all of the plurality of conditions may be satisfied, or by satisfying individual conditions, corresponding effects can be obtained.

The optical system according to the present embodiment is an optical system having the reduction conjugate point on the reduction side and the magnification conjugate point on the magnification side, and includes:
the base optical system 10 having a plurality of lenses that is rotationally symmetric with respect to an optical axis OA and an aperture stop;
the first attachment optical system 11 includes a first reflection surface group, and has a first optical characteristic; and
the second attachment optical system 12 includes a second reflection surface group, and has a second optical characteristic different from the first optical characteristic.

The base optical system is configured to allow either the first attachment optical system or the second optical system to be attached at a position closer to a magnification side than the base optical system.

In a case where the first attachment optical system 11 is attached to the base optical system 10, a vertical distance from the optical axis OA to the magnification conjugate point in a vertical direction to the magnification conjugate point perpendicular to the optical axis is set to a first shift amount SF1.

In a case where the second attachment optical system 12 is attached to the base optical system 10, the vertical distance is set to a second shift amount SF2 different from the first shift amount SF1.

According to such a configuration, by exchangeably attaching a plurality of attachment optical systems having different optical characteristics to the base optical system, the shift amount of the projection range or the imaging range can be variably set in the vertical direction from the optical axis.

In the optical system according to the present embodiment, the intermediate imaging position that is conjugate with each of the magnification conjugate point and the reduction conjugate point may be provided on an optical path of the first attachment optical system 11 attached to the base optical system 10 or the second attachment optical system 12 attached to the base optical system 10.

According to such a configuration, by providing the intermediate imaging position on the optical path of the attachment optical system, an angle is further widened as compared with the optical system in which the intermediate imaging position does not exist.

In the optical system according to the present embodiment, the first attachment optical system 11 may include a first prism PM having the first reflection surface group,
the second attachment optical system 12 may include a second prism PM having the second reflection surface group, and
the intermediate imaging position may be provided on an optical path inside the first prism PM or the second prism PM.

According to such a configuration, since the size of the light flux is small around the intermediate imaging position, the attachment optical system can be downsized.

In the optical system according to the present embodiment, the first prism PM or the second prism PM may include the first transmission surface T1, the first reflection surface R1, a second reflection surface R2, and the second transmission surface T2 in order from the reduction side to the magnification side, and the intermediate imaging position may be provided between the first transmission surface T1 and the first reflection surface R1.

According to such a configuration, since the size of the light flux is small around the intermediate imaging position, the attachment optical system can be downsized.

In the optical system according to the present embodiment, when the entire focal length fa of all the rotationally symmetric lenses included in the base optical system and each attachment optical system increases due to replacement of the first attachment optical system and the second attachment optical system, the vertical distance may increase.

According to such a configuration, it is possible to change the projection range while maintaining excellent optical performance of the entire optical system.

In the optical system according to the present embodiment, when an incident angle αi2m at which the main light ray of the light flux closest to the optical axis is incident on the second reflection surface increases due to replacement of the first attachment optical system and the second attachment optical system, the vertical distance may also increase.

As illustrated in FIG. 6A, a main light ray PR of the light flux closest to the optical axis OA is reflected by the first reflection surface R1, and then incident on a second point (yr2, zr2) on the second reflection surface R2. In this case, a normal line NA at the second point (yr2, zr2) can be defined. The incident angle at which the main light ray PR is incident on the second reflection surface R2 can be defined by the incident angle αi2m between the normal line NA at the second point and the traveling direction of the main light ray PR. Therefore, when the incident angle αi2m incident on the second reflection surface increases due to the replacement of the attachment optical systems, it is preferable that the vertical distance also increases, whereby the projection range can be changed while the optical performance of the entire optical system is kept good.

In the optical system according to the present embodiment, the first reflection surface may have positive power.

According to such a configuration, miniaturization of the optical system and reduction of the number of lenses are achieved.

In the optical system according to the present embodiment, the first reflection surface may have stronger positive power than the second reflection surface.

According to such a configuration, miniaturization of the prism is achieved.

The optical system according to the present embodiment may satisfy the following formula (1).

$$\vert ( SF / V ) \times ( H / D ) \vert > 2. 7 \qquad ( 1 )$$

Here:
D is a distance between the magnification conjugate point and the optical system,
V is a length in a first direction parallel to the vertical direction of an effective area on which a total light ray is projected or imaged in a conjugate surface including the magnification conjugate point,
H is a length in a second direction in the vertical direction of an effective area on which a total light ray is projected or imaged in a conjugate surface including the magnification conjugate point, and
SF is a vertical distance from the optical axis to a center of a length of the effective area in the first direction.

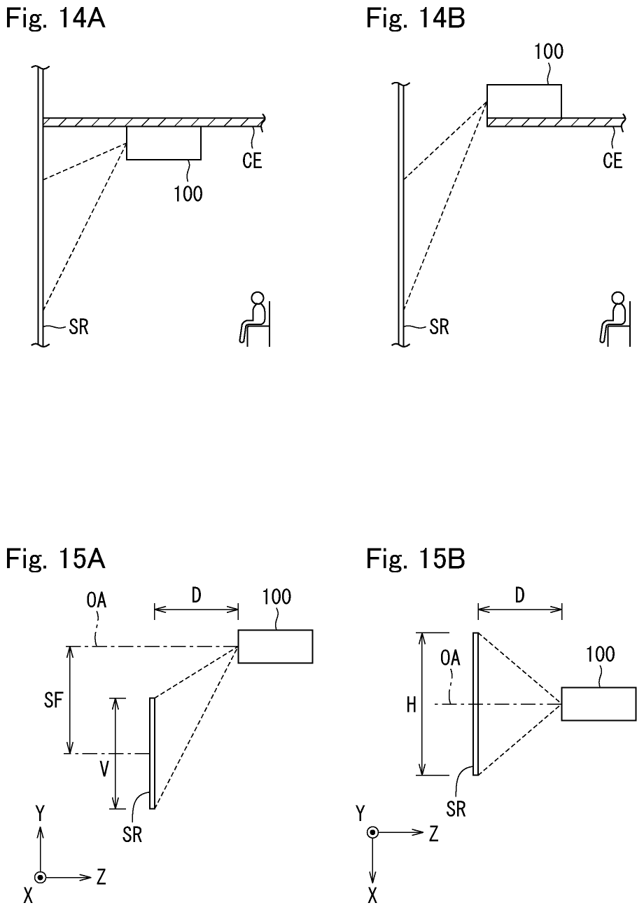

For example, as illustrated in FIG. 14A, in a case where the optical system is mounted on the image projection apparatus 100 to perform oblique projection toward the screen SR (magnification conjugate point), the image projection apparatus 100 is generally installed on the lower surface of the ceiling CE in many cases. The audience views the image projected on the screen SR, but also recognizes the presence of the image projection apparatus 100. Meanwhile, as illustrated in FIG. 14B, it can be assumed that the image projection apparatus 100 is installed on the upper surface of the ceiling CE to perform oblique projection toward the screen SR. In this case, since the image projection apparatus 100 is hidden by the ceiling CE, it is difficult for the audience to recognize the presence of the image projection apparatus 100, and the audience can immerse themselves in the image viewing. In order to realize the arrangement of FIG. 14B, an optical system capable of projecting in an oblique direction greatly inclined with respect to the screen SR is required.

Note that, in FIGS. 14A and 14B, an example has been described in which the image projection apparatus 100 is installed on the ceiling CE side and the image is projected downward, but as an alternative, the image projection apparatus 100 may be installed on the floor side and the image may be projected obliquely upward. In addition, the image projection apparatus 100 may be installed on a side wall (right side wall or left side wall) of a room, and an image may be obliquely projected in a lateral direction (left direction or right direction).

FIGS. 15A and 15B are views for explaining definitions of variables in formula (1), FIG. 15A illustrates a YZ cross-sectional view, and FIG. 15B illustrates a ZX cross-sectional view. Assuming that D is a distance between the screen SR and the optical system of the image projection apparatus 100, that H is a length in the second direction perpendicular to the vertical direction to the magnification conjugate point perpendicular to the optical axis OA in the effective area where the total light ray is projected on the screen SR, that V is a length in the first direction parallel to the vertical direction in the effective area where the total light ray is projected on the screen SR, and that SF is a vertical distance from the optical axis OA to the center of the length in the first direction of the effective area, the optical system can satisfy the formula (1). With such a configuration, it is possible to realize a configuration in which the projection distance D to the screen SR is small (so-called short-focus projection) and a vertical distance SF is large (so-called super-shift projection).

The optical system according to the present embodiment may be an optical system having the reduction conjugate point on the reduction side and the magnification conjugate point on the magnification side, and may include:
the base optical system 10 having a plurality of lenses that is rotationally symmetric with respect to an optical axis OA and an aperture stop;
the attachment optical system disposed closer to a magnification side than the base optical system 10, including a reflection surface group.

In a case where the attachment optical system is a first attachment optical system 11 including a first reflection surface group, and having a first optical characteristic, a vertical distance from the optical axis OA to the magnification conjugate point in a vertical direction to the magnification conjugate point perpendicular to the optical axis OA is set to a first shift amount SF1.

In a case where the attachment optical system is a second attachment optical system 12 including a second reflection surface group, and having a second optical characteristic different from the first optical characteristic, the vertical distance is set to a second shift amount SF2 different from the first shift amount SF1.

The optical system according to the present embodiment may be an optical system having the reduction conjugate point on the reduction side and the magnification conjugate point on the magnification side, and may include the base optical system 10 having a plurality of lenses that is rotationally symmetric with respect to an optical axis OA and an aperture stop.

The base optical system is configured to allow either the first attachment optical system or the second optical system to be attached at a position closer to a magnification side than the base optical system.

In a case where the first attachment optical system 11 is attached to the base optical system 10, a vertical distance from the optical axis OA to the magnification conjugate point in a vertical direction to the magnification conjugate point perpendicular to the optical axis is set to a first shift amount SF1.

In a case where the second attachment optical system 12 is attached to the base optical system 10, the vertical distance is set to a second shift amount SF2 different from the first shift amount SF1.

Hereinafter, numerical examples of the optical system according to first to second examples will be described. In each numerical example, the unit of the length in the table is all “mm”, and the unit of the angle of view is all “degree”. In addition, in each numerical example, an object height (XY polynomial surface, spherical surface, aspherical surface), a curvature radius, a surface interval, a d-line refractive index, a d-line Abbe number, a material, refraction/reflection, an eccentric type, and a Y eccentricity are illustrated. Various amounts of the numerical examples are calculated based on a wavelength of 550 nm. In addition, in numerical examples, the shape of the aspherical surface is defined by the following formula. Note that, as the aspherical coefficient, only a coefficient that is not 0 except the conic constant k is described.

$$[ Math 1 ]$$

$$x = \frac{{cr}^{2}}{1 + \sqrt{1 - ( 1 + k ) \text{?}}} + {Ar}^{4} + {Br}^{6} + {Cr}^{8} + {Dr}^{10} + {Er}^{12} + {Fr}^{14} + {Gr}^{16} + {Hr}^{18}$$

$$\text{?} \text{indicates text missing or illegible when filed}$$

Here:
z is a sag height of a surface parallel to the z axis,
r is a distance in radial direction (=a square root of (x²+y²)),
c is curvature at surface vertex
k is a conic constant, and
A to H are 4th to 18th order aspherical coefficients of r.

The free-form surface shape is defined by the following formula using a local orthogonal coordinate system (x, y, z) with the surface vertex as an original point.

$$z = \frac{{cr}^{2}}{1 + \sqrt{1 - ( 1 + k ) {c}^{2} {r}^{2}}} + {\sum }_{j = 2}^{137} {C}_{j} {x}^{m} {y}^{n} \qquad [ Math 2 ]$$

$$j = \frac{{( m + n )}^{2} + m + 3 n}{2} + 1 \qquad [ Math 3 ]$$

Here:
z is a sag height of a surface parallel to the z axis,
r is a distance in radial direction (=a square root of (x²+y²)),
c is curvature at surface vertex,
k is a conic constant, and
Cⱼ is a coefficient of monomial x^{m}yⁿ.

In each of the following data, an i-th order term of x and a j-th order term of y, which are free-form surface coefficients in the polynomial, are described as x**i*y**j. For example, “X**2*Y” indicates a free-form surface coefficient of a quadratic term of x and a linear term of y in the polynomial.

### First Numerical Example

For a first numerical example (corresponding to first example), the lens data of the optical system including the first attachment optical system 11 is illustrated in Table 1, the aspherical shape data of the lens is illustrated in Table 2, and the free-form surface shape data of the prism is illustrated in Table 3. The lens data of the optical system including the second attachment optical system 12 is illustrated in Table 4, the aspherical shape data of the lens is illustrated in Table 5, and the free-form surface shape data of the prism is illustrated in Table 6. The lens data of the optical system including the third attachment optical system 13 is illustrated in Table 7, the aspherical shape data of the lens is illustrated in Table 8, and the free-form surface shape data of the prism is illustrated in Table 9. Note that the eccentric type “Decenter and Return (DAR)” in Tables 1, 4, and 7 means coordinate transformation between global coordinates and local coordinates at the time of numerical calculation. The same applies to other numerical examples.

TABLE 1

| | Surface | | Curvature | | Refractive | Abbe | | Refraction/ | Eccentric | Y |
|---|---|---|---|---|---|---|---|---|---|---|
| | number | Object height | radius | Interval | index | number | Material | Reflection | type | eccentricity |
| SR | S0 | | | 1131 | | | | | | |
| T2 | S1 | XY polynomial | −1076.468 | 21.000 | 1.587 | 59.013 | KSKLD200 | Refraction | DAR | 2.115 |
| | | surface | | | | | | | | |
| R2 | S2 | XY polynomial | 1135.009 | −30.000 | 1.587 | 59.013 | KSKLD200 | Reflection | DAR | 3.437 |
| | | surface | | | | | | | | |
| R1 | S3 | XY polynomial | −297.446 | 30.000 | 1.587 | 59.013 | KSKLD200 | Reflection | DAR | 3.366 |
| | | surface | | | | | | | | |
| T1 | S4 | XY polynomial | −36.193 | 62.332 | | | | Refraction | DAR | 2.784 |
| | | surface | | | | | | | | |
| L7 | S5 | Sphere | −211.480 | 3.000 | 1.847 | 23.784 | FDS90SG | Refraction | | |
| L7 | S6 | Sphere | 160.861 | 19.395 | | | | Refraction | | |
| L6 | S7 | Sphere | −135.135 | 11.352 | 1.730 | 32.233 | NBFD32 | Refraction | | |
| L6 | S8 | Sphere | −63.704 | 13.712 | | | | Refraction | | |
| L5 | S9 | Sphere | 244.013 | 15.128 | 1.487 | 70.235 | SFSL5 | Refraction | | |
| L5 | S10 | Sphere | −85.418 | 60.743 | | | | Refraction | | |
| | S11 | Sphere | ∞ | 20.000 | | | | Refraction | | |
| ST | S12 | Sphere | ∞ | 2.252 | | | | Refraction | | |
| Aperture | | | | | | | | | | |
| stop | | | | | | | | | | |
| L4 | S13 | Sphere | 36.866 | 6.172 | 1.497 | 81.607 | FCD1 | Refraction | | |
| L4 | S14 | Sphere | −61.562 | 3.690 | | | | Refraction | | |
| L3 | S15 | Sphere | −45.653 | 1.500 | 1.738 | 32.326 | SNBH53V | Refraction | | |
| L3 | S16 | Sphere | 59.821 | 26.671 | | | | Refraction | | |
| L2 | S17 | Aspherical | 113.913 | 6.816 | 1.587 | 59.013 | KSKLD200 | Refraction | | |
| | | surface | | | | | | | | |
| L2 | S18 | Aspherical | −72.276 | 0.200 | | | | Refraction | | |
| | | surface | | | | | | | | |
| L1 | S19 | Sphere | 941.815 | 11.890 | 1.497 | 81.607 | FCD1 | Refraction | | |
| L1 | S20 | Sphere | −39.734 | 13.900 | | | | Refraction | | |
| PA | S21 | Sphere | ∞ | 34.600 | 1.517 | 64.166 | BK7 | Refraction | | |
| PA | S22 | Sphere | ∞ | 2.000 | | | | Refraction | | |
| SA | S23 | | | | | | | | | |

| | |
|---|---|
| Image height | Object height |

| | X | Y | X | Y |
|---|---|---|---|---|
| f1 | 0.000 | −1.782 | 0 | −3 |
| f2 | 0.000 | −8.100 | 0 | −1184 |
| f3 | 0.000 | −14.418 | 0 | −2358 |
| f4 | −8.640 | −1.782 | −1616 | −10 |
| f5 | −8.640 | −8.100 | −1608 | −1191 |
| f6 | −8.640 | −14.418 | −1624 | −2373 |

| | |
|---|---|
| Aperture diameter | Display element size |

| | | | |
|---|---|---|---|
| S11 | 28.008 | Long side | 17.28 |
| Aperture stop | 24.136 | Short side | 10.8 |
| S16 | 21.605 | Display element shift range | −7.182~−9.018 |

TABLE 2
Aspherical surface coefficient

| S17 | | S18 | |
|---|---|---|---|
| Conic | 0.00000E+00 | Conic | 0.00000E+00 |
| constant (K) | | constant (K) | |
| Fourth order | −2.18375E−06 | Fourth order | 3.53097E−06 |
| coefficient (A) | | coefficient (A) | |
| Sixth order | −8.46633E−10 | Sixth order | 0.00000E+00 |
| coefficient (B) | | coefficient (B) | |
| Eighth order | 0.00000E+00 | Eighth order | 0.00000E+00 |
| coefficient (C) | | coefficient (C) | |
| Tenth order | 0.00000E+00 | Tenth order | 0.00000E+00 |
| coefficient (D) | | coefficient (D) | |

TABLE 3
XY polynomial surface coefficient

| | X**0 | X**1 | X**2 | X**3 | X**4 | X**5 | X**6 | X**7 | X**8 | X**9 | X**10 |
|---|---|---|---|---|---|---|---|---|---|---|---|
| S1 | | | | | | | | | | | |
| Y**0 | | 0.00000E+00 | 1.65627E−02 | 0.00000E+00 | −9.04269E−06 | 0.00000E+00 | 4.05992E−08 | 0.00000E+00 | −6.55919E−11 | 0.00000E+00 | 4.57873E−14 |
| Y**1 | −7.04012E−02 | 0.00000E+00 | 2.34699E−04 | 0.00000E+00 | −4.37535E−07 | 0.00000E+00 | 4.43720E−10 | 0.00000E+00 | 0.00000E+00 | 0.00000E+00 | |
| Y**2 | 1.32455E−02 | 0.00000E+00 | 1.68773E−05 | 0.00000E+00 | 4.06440E−08 | 0.00000E+00 | −1.02869E−10 | 0.00000E+00 | 1.25593E−13 | | |
| Y**3 | −1.43773E−04 | 0.00000E+00 | 8.95600E−07 | 0.00000E+00 | 1.28076E−09 | 0.00000E+00 | 0.00000E+00 | 0.00000E+00 | | | |
| Y**4 | −7.40927E−06 | 0.00000E+00 | 6.61604E−08 | 0.00000E+00 | −2.29794E−11 | 0.00000E+00 | 1.10494E−13 | | | | |
| Y**5 | −1.10369E−08 | 0.00000E+00 | 9.78720E−10 | 0.00000E+00 | 0.00000E+00 | 0.00000E+00 | | | | | |
| Y**6 | 1.73753E−08 | 0.00000E+00 | −3.01527E−11 | 0.00000E+00 | 4.22235E−14 | | | | | | |
| Y**7 | −1.08307E−10 | 0.00000E+00 | 0.00000E+00 | 0.00000E+00 | | | | | | | |
| Y**8 | −2.10727E−11 | 0.00000E+00 | 2.98031E−14 | | | | | | | | |
| Y**9 | 0.00000E+00 | 0.00000E+00 | | | | | | | | | |
| Y**10 | 9.56499E−15 | | | | | | | | | | |
| S2 | | | | | | | | | | | |
| Y**0 | | 0.00000E+00 | −9.63101E−04 | 0.00000E+00 | 1.84541E−06 | 0.00000E+00 | 0.00000E+00 | 0.00000E+00 | 0.00000E+00 | 0.00000E+00 | 0.00000E+00 |
| Y**1 | 3.83042E−02 | 0.00000E+00 | 1.32238E−05 | 0.00000E+00 | 0.00000E+00 | 0.00000E+00 | 0.00000E+00 | 0.00000E+00 | 0.00000E+00 | 0.00000E+00 | |
| Y**2 | −1.00606E−03 | 0.00000E+00 | 9.62505E−08 | 0.00000E+00 | 0.00000E+00 | 0.00000E+00 | 0.00000E+00 | 0.00000E+00 | 0.00000E+00 | | |
| Y**3 | 6.60011E−06 | 0.00000E+00 | 0.00000E+00 | 0.00000E+00 | 0.00000E+00 | 0.00000E+00 | 0.00000E+00 | 0.00000E+00 | | | |
| Y**4 | 1.51090E−07 | 0.00000E+00 | 0.00000E+00 | 0.00000E+00 | 0.00000E+00 | 0.00000E+00 | 0.00000E+00 | | | | |
| Y**5 | 0.00000E+00 | 0.00000E+00 | 0.00000E+00 | 0.00000E+00 | 0.00000E+00 | 0.00000E+00 | | | | | |
| Y**6 | 0.00000E+00 | 0.00000E+00 | 0.00000E+00 | 0.00000E+00 | 0.00000E+00 | | | | | | |
| Y**7 | 0.00000E+00 | 0.00000E+00 | 0.00000E+00 | 0.00000E+00 | | | | | | | |
| Y**8 | 0.00000E+00 | 0.00000E+00 | 0.00000E+00 | | | | | | | | |
| Y**9 | 0.00000E+00 | 0.00000E+00 | | | | | | | | | |
| Y**10 | 0.00000E+00 | | | | | | | | | | |
| S3 | | | | | | | | | | | |
| Y**0 | | 0.00000E+00 | 1.46226E−02 | 0.00000E+00 | 2.13417E−05 | 0.00000E+00 | −1.18826E−07 | 0.00000E+00 | 2.31332E−10 | 0.00000E+00 | −1.58371E−13 |
| Y**1 | 5.33725E−02 | 0.00000E+00 | 2.66114E−05 | 0.00000E+00 | −3.16799E−08 | 0.00000E+00 | 0.00000E+00 | 0.00000E+00 | 0.00000E+00 | 0.00000E+00 | |
| Y**2 | 1.38259E−02 | 0.00000E+00 | 3.33037E−06 | 0.00000E+00 | −3.45037E−08 | 0.00000E+00 | 1.34424E−10 | 0.00000E+00 | −1.48161E−13 | | |
| Y**3 | 2.82083E−05 | 0.00000E+00 | −4.51419E−07 | 0.00000E+00 | 0.00000E+00 | 0.00000E+00 | 0.00000E+00 | 0.00000E+00 | | | |
| Y**4 | −8.13106E−08 | 0.00000E+00 | 8.24575E−09 | 0.00000E+00 | 1.35017E−11 | 0.00000E+00 | −4.03624E−14 | | | | |
| Y**5 | 2.72164E−07 | 0.00000E+00 | 0.00000E+00 | 0.00000E+00 | 0.00000E+00 | 0.00000E+00 | | | | | |
| Y**6 | −1.77988E−08 | 0.00000E+00 | 1.25522E−12 | 0.00000E+00 | −7.04065E−15 | | | | | | |
| Y**7 | 0.00000E+00 | 0.00000E+00 | 0.00000E+00 | 0.00000E+00 | | | | | | | |
| Y**8 | 1.18063E−11 | 0.00000E+00 | −4.37174E−15 | | | | | | | | |
| Y**9 | 0.00000E+00 | 0.00000E+00 | | | | | | | | | |
| Y**10 | −4.29595E−15 | | | | | | | | | | |
| S4 | | | | | | | | | | | |
| Y**0 | | 0.00000E+00 | 3.49835E−02 | 0.00000E+00 | −1.43957E−04 | 0.00000E+00 | 5.45665E−07 | 0.00000E+00 | −1.03861E−09 | 0.00000E+00 | 7.88397E−13 |
| Y**1 | −8.02777E−02 | 0.00000E+00 | 1.14157E−05 | 0.00000E+00 | −7.42515E−07 | 0.00000E+00 | 0.00000E+00 | 0.00000E+00 | 0.00000E+00 | 0.00000E+00 | |
| Y**2 | 2.48494E−02 | 0.00000E+00 | −7.02567E−06 | 0.00000E+00 | 5.07190E−07 | 0.00000E+00 | −9.30369E−10 | 0.00000E+00 | 7.08998E−13 | | |
| Y**3 | 8.08081E−04 | 0.00000E+00 | −1.20232E−05 | 0.00000E+00 | 0.00000E+00 | 0.00000E+00 | 0.00000E+00 | 0.00000E+00 | | | |
| Y**4 | −4.67321E−05 | 0.00000E+00 | 6.18140E−07 | 0.00000E+00 | −5.41936E−10 | 0.00000E+00 | 4.82423E−13 | | | | |
| Y**5 | −1.07320E−06 | 0.00000E+00 | 0.00000E+00 | 0.00000E+00 | 0.00000E+00 | 0.00000E+00 | | | | | |
| Y**6 | 8.83209E−08 | 0.00000E+00 | −3.59825E−10 | 0.00000E+00 | 1.96478E−13 | | | | | | |
| Y**7 | 0.00000E+00 | 0.00000E+00 | 0.00000E+00 | 0.00000E+00 | | | | | | | |
| Y**8 | −5.38231E−11 | 0.00000E+00 | 1.16608E−13 | | | | | | | | |
| Y**9 | 0.00000E+00 | 0.00000E+00 | | | | | | | | | |
| Y**10 | 1.85966E−14 | | | | | | | | | | |

TABLE 4

| | Surface | | Curvature | | Refractive | Abbe | | Refraction/ | Eccentric | Y |
|---|---|---|---|---|---|---|---|---|---|---|
| | number | Object height | radius | Interval | index | number | Material | Reflection | type | eccentricity |
| SR | S0 | | | 1131 | | | | | | |
| T2 | S1 | XY polynomial | −336.862 | 17.267 | 1.587 | 59.013 | KSKLD200 | Refraction | DAR | 0 |
| | | surface | | | | | | | | |
| R2 | S2 | XY polynomial | −3299.737 | −27.837 | 1.587 | 59.013 | KSKLD200 | Reflection | DAR | 0 |
| | | surface | | | | | | | | |
| R1 | S3 | XY polynomial | −1775.662 | 30.000 | 1.587 | 59.013 | KSKLD200 | Reflection | DAR | 0 |
| | | surface | | | | | | | | |
| T1 | S4 | XY polynomial | −34.677 | 60.000 | | | | Refraction | DAR | 0 |
| | | surface | | | | | | | | |
| L7 | S5 | Sphere | −575.038 | 3.000 | 1.847 | 23.784 | FDS90SG | Refraction | | |
| L7 | S6 | Sphere | 150.431 | 8.802 | | | | Refraction | | |
| L6 | S7 | Sphere | −124.505 | 11.591 | 1.770 | 29.735 | NBFD29 | Refraction | | |
| L6 | S8 | Sphere | −60.452 | 31.045 | | | | Refraction | | |
| L5 | S9 | Sphere | 244.013 | 15.128 | 1.487 | 70.235 | SFSL5 | Refraction | | |
| L5 | S10 | Sphere | −85.418 | 60.743 | | | | Refraction | | |
| | S11 | Sphere | ∞ | 20.000 | | | | Refraction | | |
| ST | S12 | Sphere | ∞ | 2.252 | | | | Refraction | | |
| Aperture | | | | | | | | | | |
| stop | | | | | | | | | | |
| L4 | S13 | Sphere | 36.866 | 6.172 | 1.497 | 81.607 | FCD1 | Refraction | | |
| L4 | S14 | Sphere | −61.562 | 3.690 | | | | Refraction | | |
| L3 | S15 | Sphere | −45.653 | 1.500 | 1.738 | 32.326 | SNBH53V | Refraction | | |
| L3 | S16 | Sphere | 59.821 | 26.671 | | | | Refraction | | |
| L2 | S17 | Aspherical | 113.913 | 6.816 | 1.587 | 59.013 | KSKLD200 | Refraction | | |
| | | surface | | | | | | | | |
| L2 | S18 | Aspherical | −72.276 | 0.200 | | | | Refraction | | |
| | | surface | | | | | | | | |
| L1 | S19 | Sphere | 941.815 | 11.890 | 1.497 | 81.607 | FCD1 | Refraction | | |
| L1 | S20 | Sphere | −39.734 | 13.900 | | | | Refraction | | |
| PA | S21 | Sphere | ∞ | 34.600 | 1.517 | 64.166 | BK7 | Refraction | | |
| PA | S22 | Sphere | ∞ | 2.000 | | | | Refraction | | |
| SA | S23 | | | | | | | | | |

| | |
|---|---|
| Image height | Object height |

| | X | Y | X | Y |
|---|---|---|---|---|
| f1 | 0.000 | −1.782 | 0 | −329 |
| f2 | 0.000 | −8.100 | 0 | −1504 |
| f3 | 0.000 | −14.418 | 0 | −2689 |
| f4 | −8.640 | −1.782 | −1616 | −323 |
| f5 | −8.640 | −8.100 | −1624 | −1508 |
| f6 | −8.640 | −14.418 | −1608 | −2670 |

| | |
|---|---|
| Aperture diameter | Display element size |

| | | | |
|---|---|---|---|
| S11 | 28.008 | Long side | 17.28 |
| Aperture stop | 24.136 | Short side | 10.8 |
| S16 | 21.605 | Display element shift range | −7.182~−9.018 |

TABLE 5
Aspherical surface coefficient

| S17 | | S18 | |
|---|---|---|---|
| Conic | 0.00000E+00 | Conic | 0.00000E+00 |
| constant (K) | | constant (K) | |
| Fourth order | −2.18375E−06 | Fourth order | 3.53097E−06 |
| coefficient (A) | | coefficient (A) | |
| Sixth order | −8.46633E−10 | Sixth order | 0.00000E+00 |
| coefficient (B) | | coefficient (B) | |
| Eighth order | 0.00000E+00 | Eighth order | 0.00000E+00 |
| coefficient (C) | | coefficient (C) | |
| Tenth order | 0.00000E+00 | Tenth order | 0.00000E+00 |
| coefficient (D) | | coefficient (D) | |

TABLE 6
XY polynomial surface coefficient

| | X**0 | X**1 | X**2 | X**3 | X**4 | X**5 | X**6 | X**7 | X**8 | X**9 | X**10 |
|---|---|---|---|---|---|---|---|---|---|---|---|
| S1 | | | | | | | | | | | |
| Y**0 | | 0.00000E+00 | 1.11045E−02 | 0.00000E+00 | 5.44191E−06 | 0.00000E+00 | −2.94131E−09 | 0.00000E+00 | 4.55173E−12 | 0.00000E+00 | −3.03564E−16 |
| Y**1 | 0.00000E+00 | 0.00000E+00 | 0.00000E+00 | 0.00000E+00 | 0.00000E+00 | 0.00000E+00 | 0.00000E+00 | 0.00000E+00 | 0.00000E+00 | 0.00000E+00 | |
| Y**2 | 1.14925E−02 | 0.00000E+00 | 9.99359E−06 | 0.00000E+00 | −3.56014E−09 | 0.00000E+00 | 9.81283E−12 | 0.00000E+00 | 2.16908E−15 | | |
| Y**3 | 0.00000E+00 | 0.00000E+00 | 0.00000E+00 | 0.00000E+00 | 0.00000E+00 | 0.00000E+00 | 0.00000E+00 | 0.00000E+00 | | | |
| Y**4 | 3.33949E−06 | 0.00000E+00 | 2.63039E−09 | 0.00000E+00 | −1.48617E−13 | 0.00000E+00 | 1.39420E−14 | | | | |
| Y**5 | 0.00000E+00 | 0.00000E+00 | 0.00000E+00 | 0.00000E+00 | 0.00000E+00 | 0.00000E+00 | | | | | |
| Y**6 | 4.15699E−09 | 0.00000E+00 | −1.01770E−11 | 0.00000E+00 | 2.64520E−14 | | | | | | |
| Y**7 | 0.00000E+00 | 0.00000E+00 | 0.00000E+00 | 0.00000E+00 | | | | | | | |
| Y**8 | −5.75966E−12 | 0.00000E+00 | 1.85269E−14 | | | | | | | | |
| Y**9 | 0.00000E+00 | 0.00000E+00 | | | | | | | | | |
| Y**10 | 4.94823E−15 | | | | | | | | | | |
| S2 | | | | | | | | | | | |
| Y**0 | | 0.00000E+00 | 4.46320E−05 | 0.00000E+00 | 0.00000E+00 | 0.00000E+00 | 0.00000E+00 | 0.00000E+00 | 0.00000E+00 | 0.00000E+00 | 0.00000E+00 |
| Y**1 | 0.00000E+00 | 0.00000E+00 | 0.00000E+00 | 0.00000E+00 | 0.00000E+00 | 0.00000E+00 | 0.00000E+00 | 0.00000E+00 | 0.00000E+00 | 0.00000E+00 | |
| Y**2 | −7.37078E−05 | 0.00000E+00 | −7.67252E−08 | 0.00000E+00 | 0.00000E+00 | 0.00000E+00 | 0.00000E+00 | 0.00000E+00 | 0.00000E+00 | | |
| Y**3 | 0.00000E+00 | 0.00000E+00 | 0.00000E+00 | 0.00000E+00 | 0.00000E+00 | 0.00000E+00 | 0.00000E+00 | 0.00000E+00 | | | |
| Y**4 | 0.00000E+00 | 0.00000E+00 | 0.00000E+00 | 0.00000E+00 | 0.00000E+00 | 0.00000E+00 | 0.00000E+00 | | | | |
| Y**5 | 0.00000E+00 | 0.00000E+00 | 0.00000E+00 | 0.00000E+00 | 0.00000E+00 | 0.00000E+00 | | | | | |
| Y**6 | 0.00000E+00 | 0.00000E+00 | 0.00000E+00 | 0.00000E+00 | 0.00000E+00 | | | | | | |
| Y**7 | 0.00000E+00 | 0.00000E+00 | 0.00000E+00 | 0.00000E+00 | | | | | | | |
| Y**8 | 0.00000E+00 | 0.00000E+00 | 0.00000E+00 | | | | | | | | |
| Y**9 | 0.00000E+00 | 0.00000E+00 | | | | | | | | | |
| Y**10 | 0.00000E+00 | | | | | | | | | | |
| S3 | | | | | | | | | | | |
| Y**0 | | 0.00000E+00 | 1.25642E−02 | 0.00000E+00 | 1.09015E−05 | 0.00000E+00 | −7.91868E−08 | 0.00000E+00 | 1.88962E−10 | 0.00000E+00 | −1.69962E−13 |
| Y**1 | 0.00000E+00 | 0.00000E+00 | 0.00000E+00 | 0.00000E+00 | 0.00000E+00 | 0.00000E+00 | 0.00000E+00 | 0.00000E+00 | 0.00000E+00 | 0.00000E+00 | |
| Y**2 | 1.27062E−02 | 0.00000E+00 | 1.41079E−06 | 0.00000E+00 | −6.39270E−08 | 0.00000E+00 | 2.01733E−10 | 0.00000E+00 | −2.42355E−13 | | |
| Y**3 | 0.00000E+00 | 0.00000E+00 | 0.00000E+00 | 0.00000E+00 | 0.00000E+00 | 0.00000E+00 | 0.00000E+00 | 0.00000E+00 | | | |
| Y**4 | 5.20715E−07 | 0.00000E+00 | −2.89402E−08 | 0.00000E+00 | 1.08514E−10 | 0.00000E+00 | −1.78505E−13 | | | | |
| Y**5 | 0.00000E+00 | 0.00000E+00 | 0.00000E+00 | 0.00000E+00 | 0.00000E+00 | 0.00000E+00 | | | | | |
| Y**6 | −1.04814E−08 | 0.00000E+00 | 4.80737E−11 | 0.00000E+00 | −1.08657E−13 | | | | | | |
| Y**7 | 0.00000E+00 | 0.00000E+00 | 0.00000E+00 | 0.00000E+00 | | | | | | | |
| Y**8 | 1.36780E−11 | 0.00000E+00 | −4.87305E−14 | | | | | | | | |
| Y**9 | 0.00000E+00 | 0.00000E+00 | | | | | | | | | |
| Y**10 | −1.04355E−14 | | | | | | | | | | |
| S4 | | | | | | | | | | | |
| Y**0 | | 0.00000E+00 | 2.08235E−02 | 0.00000E+00 | −3.21106E−05 | 0.00000E+00 | 1.19529E−07 | 0.00000E+00 | −3.23064E−10 | 0.00000E+00 | 3.31237E−13 |
| Y**1 | 0.00000E+00 | 0.00000E+00 | 0.00000E+00 | 0.00000E+00 | 0.00000E+00 | 0.00000E+00 | 0.00000E+00 | 0.00000E+00 | 0.00000E+00 | 0.00000E+00 | |
| Y**2 | 2.45121E−02 | 0.00000E+00 | −7.90062E−05 | 0.00000E+00 | 1.75820E−07 | 0.00000E+00 | −1.93138E−10 | 0.00000E+00 | 1.03056E−13 | | |
| Y**3 | 0.00000E+00 | 0.00000E+00 | 0.00000E+00 | 0.00000E+00 | 0.00000E+00 | 0.00000E+00 | 0.00000E+00 | 0.00000E+00 | | | |
| Y**4 | −3.68618E−05 | 0.00000E+00 | 1.77155E−07 | 0.00000E+00 | −2.99070E−10 | 0.00000E+00 | 1.68135E−13 | | | | |
| Y**5 | 0.00000E+00 | 0.00000E+00 | 0.00000E+00 | 0.00000E+00 | 0.00000E+00 | 0.00000E+00 | | | | | |
| Y**6 | 5.31940E−08 | 0.00000E+00 | −1.80876E−10 | 0.00000E+00 | 1.66537E−13 | | | | | | |
| Y**7 | 0.00000E+00 | 0.00000E+00 | 0.00000E+00 | 0.00000E+00 | | | | | | | |
| Y**8 | −4.16947E−11 | 0.00000E+00 | 7.23888E−14 | | | | | | | | |
| Y**9 | 0.00000E+00 | 0.00000E+00 | | | | | | | | | |
| Y**10 | 1.41648E−14 | | | | | | | | | | |

TABLE 7

| | Surface | | Curvature | | Refractive | Abbe | | Refraction/ | Eccentric | Y |
|---|---|---|---|---|---|---|---|---|---|---|
| | number | Object height | radius | Interval | index | number | Material | Reflection | type | eccentricity |
| SR | S0 | | | 1131 | | | | | | |
| T2 | S1 | XY polynomial | −305.943 | 17.150 | 1.587 | 59.013 | KSKLD200 | Refraction | DAR | −19.5173 |
| | | surface | | | | | | | | |
| R2 | S2 | XY polynomial | 592.585 | −30.000 | 1.587 | 59.013 | KSKLD200 | Reflection | DAR | −19.2736 |
| | | surface | | | | | | | | |
| R1 | S3 | XY polynomial | 348.852 | 28.171 | 1.587 | 59.013 | KSKLD200 | Reflection | DAR | −13.1971 |
| | | surface | | | | | | | | |
| T1 | S4 | XY polynomial | −24.910 | 62.178 | | | | Refraction | DAR | 9.95137 |
| | | surface | | | | | | | | |
| L7 | S5 | Sphere | −157.621 | 3.000 | 1.847 | 23.784 | FDS90SG | Refraction | | |
| L7 | S6 | Sphere | 249.158 | 6.003 | | | | Refraction | | |
| L6 | S7 | Sphere | −162.392 | 12.328 | 1.859 | 29.997 | NBFD30 | Refraction | | |
| L6 | S8 | Sphere | −62.086 | 27.204 | | | | Refraction | | |
| L5 | S9 | Sphere | 244.013 | 15.128 | 1.487 | 70.235 | SFSL5 | Refraction | | |
| L5 | S10 | Sphere | −85.418 | 60.743 | | | | Refraction | | |
| | S11 | Sphere | ∞ | 20.000 | | | | Refraction | | |
| ST | S12 | Sphere | ∞ | 2.252 | | | | Refraction | | |
| Aperture | | | | | | | | | | |
| stop | | | | | | | | | | |
| L4 | S13 | Sphere | 36.866 | 6.172 | 1.497 | 81.607 | FCD1 | Refraction | | |
| L4 | S14 | Sphere | −61.562 | 3.690 | | | | Refraction | | |
| L3 | S15 | Sphere | −45.653 | 1.500 | 1.738 | 32.326 | SNBH53V | Refraction | | |
| L3 | S16 | Sphere | 59.821 | 26.671 | | | | Refraction | | |
| L2 | S17 | Aspherical | 113.913 | 6.816 | 1.587 | 59.013 | KSKLD200 | Refraction | | |
| | | surface | | | | | | | | |
| L2 | S18 | Aspherical | −72.276 | 0.200 | | | | Refraction | | |
| | | surface | | | | | | | | |
| L1 | S19 | Sphere | 941.815 | 11.890 | 1.497 | 81.607 | FCD1 | Refraction | | |
| L1 | S20 | Sphere | −39.734 | 13.900 | | | | Refraction | | |
| PA | S21 | Sphere | ∞ | 34.600 | 1.517 | 64.166 | BK7 | Refraction | | |
| PA | S22 | Sphere | ∞ | 2.000 | | | | Refraction | | |
| SA | S23 | | | | | | | | | |

| | |
|---|---|
| Image height | Object height |

| | X | Y | X | Y |
|---|---|---|---|---|
| f1 | 0.000 | −1.782 | 0 | −666 |
| f2 | 0.000 | −8.100 | 0 | −1841 |
| f3 | 0.000 | −14.418 | 0 | −3037 |
| f4 | −8.640 | −1.782 | −1616 | −672 |
| f5 | −8.640 | −8.100 | −1624 | −1841 |
| f6 | −8.640 | −14.418 | −1624 | −3042 |

| | |
|---|---|
| Aperture diameter | Display element size |

| | | | |
|---|---|---|---|
| S11 | 28.008 | Long side | 17.28 |
| Aperture stop | 24.136 | Short side | 10.8 |
| S16 | 21.605 | Display element shift range | −7.182~−9.018 |

TABLE 8
Aspherical surface coefficient

| S17 | | S18 | |
|---|---|---|---|
| Conic | 0.00000E+00 | Conic | 0.00000E+00 |
| constant (K) | | constant (K) | |
| Fourth order | −2.18375E−06 | Fourth order | 3.53097E−06 |
| coefficient (A) | | coefficient (A) | |
| Sixth order | −8.46633E−10 | Sixth order | 0.00000E+00 |
| coefficient (B) | | coefficient (B) | |
| Eighth order | 0.00000E+00 | Eighth order | 0.00000E+00 |
| coefficient (C) | | coefficient (C) | |
| Tenth order | 0.00000E+00 | Tenth order | 0.00000E+00 |
| coefficient (D) | | coefficient (D) | |

TABLE 9
XY polynomial surface coefficient

| | X**0 | X**1 | X**2 | X**3 | X**4 | X**5 | X**6 | X**7 | X**8 | X**9 | X**10 |
|---|---|---|---|---|---|---|---|---|---|---|---|
| S1 | | | | | | | | | | | |
| Y**0 | | 0.00000E+00 | 1.50811E−02 | 0.00000E+00 | 6.26690E−06 | 0.00000E+00 | −3.45326E−09 | 0.00000E+00 | 3.17778E−11 | 0.00000E+00 | −3.58947E−14 |
| Y**1 | −4.87977E−01 | 0.00000E+00 | −3.92703E−04 | 0.00000E+00 | −1.88726E−07 | 0.00000E+00 | −3.49237E−10 | 0.00000E+00 | −6.91372E−13 | 0.00000E+00 | |
| Y**2 | 2.18847E−02 | 0.00000E+00 | 1.89724E−05 | 0.00000E+00 | 2.94062E−08 | 0.00000E+00 | 9.16657E−11 | 0.00000E+00 | −8.34204E−17 | | |
| Y**3 | −5.27660E−04 | 0.00000E+00 | −5.32089E−07 | 0.00000E+00 | −2.32093E−09 | 0.00000E+00 | −7.46087E−12 | 0.00000E+00 | | | |
| Y**4 | 8.49779E−06 | 0.00000E+00 | 1.61259E−07 | 0.00000E+00 | 2.12787E−11 | 0.00000E+00 | 3.74642E−13 | | | | |
| Y**5 | −1.07758E−06 | 0.00000E+00 | −1.49769E−10 | 0.00000E+00 | −3.45702E−11 | 0.00000E+00 | | | | | |
| Y**6 | 1.74131E−07 | 0.00000E+00 | −6.91429E−10 | 0.00000E+00 | 2.72016E−12 | | | | | | |
| Y**7 | 2.75488E−09 | 0.00000E+00 | −6.03658E−11 | 0.00000E+00 | | | | | | | |
| Y**8 | −9.34846E−10 | 0.00000E+00 | 6.01946E−12 | | | | | | | | |
| Y**9 | −3.98296E−11 | 0.00000E+00 | | | | | | | | | |
| Y**10 | 4.38520E−12 | | | | | | | | | | |
| S2 | | | | | | | | | | | |
| Y**0 | | 0.00000E+00 | −6.02011E−04 | 0.00000E+00 | 4.74904E−06 | 0.00000E+00 | 0.00000E+00 | 0.00000E+00 | 0.00000E+00 | 0.00000E+00 | 0.00000E+00 |
| Y**1 | −5.28258E−02 | 0.00000E+00 | −4.42038E−05 | 0.00000E+00 | −3.81142E−07 | 0.00000E+00 | 0.00000E+00 | 0.00000E+00 | 0.00000E+00 | 0.00000E+00 | |
| Y**2 | −1.82294E−04 | 0.00000E+00 | 3.86661E−06 | 0.00000E+00 | 0.00000E+00 | 0.00000E+00 | 0.00000E+00 | 0.00000E+00 | 0.00000E+00 | | |
| Y**3 | −3.12334E−05 | 0.00000E+00 | −8.31133E−08 | 0.00000E+00 | 0.00000E+00 | 0.00000E+00 | 0.00000E+00 | 0.00000E+00 | | | |
| Y**4 | 6.33979E−07 | 0.00000E+00 | 0.00000E+00 | 0.00000E+00 | 0.00000E+00 | 0.00000E+00 | 0.00000E+00 | | | | |
| Y**5 | 0.00000E+00 | 0.00000E+00 | 0.00000E+00 | 0.00000E+00 | 0.00000E+00 | 0.00000E+00 | | | | | |
| Y**6 | 0.00000E+00 | 0.00000E+00 | 0.00000E+00 | 0.00000E+00 | 0.00000E+00 | | | | | | |
| Y**7 | 0.00000E+00 | 0.00000E+00 | 0.00000E+00 | 0.00000E+00 | | | | | | | |
| Y**8 | 0.00000E+00 | 0.00000E+00 | 0.00000E+00 | | | | | | | | |
| Y**9 | 0.00000E+00 | 0.00000E+00 | | | | | | | | | |
| Y**10 | 0.00000E+00 | | | | | | | | | | |
| S3 | | | | | | | | | | | |
| Y**0 | | 0.00000E+00 | 9.41512E−03 | 0.00000E+00 | 4.22391E−05 | 0.00000E+00 | −1.97582E−07 | 0.00000E+00 | 3.46385E−10 | 0.00000E+00 | −2.23292E−13 |
| Y**1 | −2.36356E−01 | 0.00000E+00 | −2.17982E−04 | 0.00000E+00 | 5.07070E−07 | 0.00000E+00 | 4.91933E−10 | 0.00000E+00 | 0.00000E+00 | 0.00000E+00 | |
| Y**2 | 2.49941E−02 | 0.00000E+00 | 1.12757E−05 | 0.00000E+00 | −1.08501E−07 | 0.00000E+00 | 1.67161E−10 | 0.00000E+00 | −1.68870E−13 | | |
| Y**3 | −1.12004E−03 | 0.00000E+00 | 2.33691E−07 | 0.00000E+00 | 1.88363E−09 | 0.00000E+00 | 0.00000E+00 | 0.00000E+00 | | | |
| Y**4 | 2.58788E−05 | 0.00000E+00 | −2.06327E−08 | 0.00000E+00 | −7.37892E−12 | 0.00000E+00 | −3.78627E−14 | | | | |
| Y**5 | 2.94396E−07 | 0.00000E+00 | 4.18271E−10 | 0.00000E+00 | 0.00000E+00 | 0.00000E+00 | | | | | |
| Y**6 | −1.67861E−08 | 0.00000E+00 | −4.98296E−12 | 0.00000E+00 | 0.00000E+00 | | | | | | |
| Y**7 | −7.54499E−11 | 0.00000E+00 | 0.00000E+00 | 0.00000E+00 | | | | | | | |
| Y**8 | 6.48916E−12 | 0.00000E+00 | 0.00000E+00 | | | | | | | | |
| Y**9 | 0.00000E+00 | 0.00000E+00 | | | | | | | | | |
| Y**10 | −1.03332E−15 | | | | | | | | | | |
| S4 | | | | | | | | | | | |
| Y**0 | | 0.00000E+00 | 2.14545E−02 | 0.00000E+00 | 1.25935E−04 | 0.00000E+00 | −9.76665E−07 | 0.00000E+00 | 3.11269E−09 | 0.00000E+00 | −3.39591E−12 |
| Y**1 | 1.50130E−01 | 0.00000E+00 | −1.55014E−03 | 0.00000E+00 | 2.45075E−06 | 0.00000E+00 | −2.58417E−09 | 0.00000E+00 | 0.00000E+00 | 0.00000E+00 | |
| Y**2 | 2.15699E−02 | 0.00000E+00 | 2.79773E−05 | 0.00000E+00 | −8.18191E−08 | 0.00000E+00 | 6.16416E−10 | 0.00000E+00 | −1.04253E−12 | | |
| Y**3 | −1.93003E−03 | 0.00000E+00 | 1.13503E−06 | 0.00000E+00 | 8.47425E−10 | 0.00000E+00 | 0.00000E+00 | 0.00000E+00 | | | |
| Y**4 | 1.10859E−05 | 0.00000E+00 | 2.65338E−07 | 0.00000E+00 | −1.67008E−09 | 0.00000E+00 | 2.70718E−12 | | | | |
| Y**5 | 9.22577E−06 | 0.00000E+00 | 5.48155E−09 | 0.00000E+00 | 0.00000E+00 | 0.00000E+00 | | | | | |
| Y**6 | −4.33537E−07 | 0.00000E+00 | −1.45971E−09 | 0.00000E+00 | 2.39933E−12 | | | | | | |
| Y**7 | −1.19514E−09 | 0.00000E+00 | 0.00000E+00 | 0.00000E+00 | | | | | | | |
| Y**8 | 2.89623E−10 | 0.00000E+00 | 1.76050E−12 | | | | | | | | |
| Y**9 | 0.00000E+00 | 0.00000E+00 | | | | | | | | | |
| Y**10 | 0.00000E+00 | | | | | | | | | | |

### Second Numerical Example

For a second numerical example (corresponding to second example), the lens data of the optical system including the first attachment optical system 11 is illustrated in Table 10, the aspherical shape data of the lens is illustrated in Table 11, and the free-form surface shape data of the prism is illustrated in Table 12. The lens data of the optical system including the second attachment optical system 12 is illustrated in Table 13, the aspherical shape data of the lens is illustrated in Table 14, and the free-form surface shape data of the prism is illustrated in Table 15. The lens data of the optical system including the third attachment optical system 13 is illustrated in Table 16, the aspherical shape data of the lens is illustrated in Table 17, and the free-form surface shape data of the prism is illustrated in Table 18.

TABLE 10

| | Surface | | Curvature | | Refractive | Abbe | | Refraction/ | Eccentric | Y |
|---|---|---|---|---|---|---|---|---|---|---|
| | number | Object height | radius | Interval | index | number | Material | Reflection | type | eccentricity |
| SR | S0 | | | 1131 | | | | | | |
| T2 | S1 | XY polynomial | −511.333 | 27.235 | 1.589 | 61.264 | KSKLD5 | Refraction | DAR | 1.640 |
| | | surface | | | | | | | | |
| R2 | S2 | XY polynomial | 1377.094 | −25.627 | 1.589 | 61.264 | KSKLD5 | Reflection | DAR | −7.061 |
| | | surface | | | | | | | | |
| R1 | S3 | XY polynomial | 90.387 | 26.098 | 1.589 | 61.264 | KSKLD5 | Reflection | DAR | −0.059 |
| | | surface | | | | | | | | |
| T1 | S4 | XY polynomial | −33.184 | 32.297 | | | | Refraction | DAR | −0.278 |
| | | surface | | | | | | | | |
| L7 | S5 | Sphere | −76.961 | 3.000 | 1.847 | 23.784 | FDS90SG | Refraction | | |
| L7 | S6 | Sphere | −1205.078 | 7.872 | | | | Refraction | | |
| L6 | S7 | Sphere | −67.161 | 10.600 | 1.702 | 41.148 | BAFD7 | Refraction | | |
| L6 | S8 | Sphere | −47.109 | 12.636 | | | | Refraction | | |
| L5 | S9 | Sphere | −426.579 | 12.734 | 1.729 | 54.673 | TAC8 | Refraction | | |
| L5 | S10 | Sphere | −67.919 | 55.998 | | | | Refraction | | |
| | S11 | Sphere | ∞ | 15.000 | | | | Refraction | | |
| ST | S12 | Sphere | ∞ | 12.289 | | | | Refraction | | |
| Aperture | | | | | | | | | | |
| stop | | | | | | | | | | |
| L4 | S13 | Sphere | 39.314 | 9.226 | 1.437 | 95.099 | FCD100 | Refraction | | |
| L4 | S14 | Sphere | −34.812 | 2.937 | | | | Refraction | | |
| L3 | S15 | Sphere | −28.242 | 1.500 | 1.673 | 38.255 | SNBH52V | Refraction | | |
| L3 | S16 | Sphere | 78.147 | 10.561 | | | | Refraction | | |
| L2 | S17 | Aspherical | 89.227 | 11.291 | 1.589 | 61.264 | ‘KSKLD5’ | Refraction | | |
| | | surface | | | | | | | | |
| L2 | S18 | Aspherical | −42.016 | 0.399 | | | | Refraction | | |
| | | surface | | | | | | | | |
| L1 | S19 | Sphere | −262.410 | 12.825 | 1.437 | 95.099 | FCD100 | Refraction | | |
| L1 | S20 | Sphere | −33.131 | 13.900 | | | | Refraction | | |
| PA | S21 | Sphere | ∞ | 34.600 | 1.517 | 64.166 | BK7 | Refraction | | |
| PA | S22 | Sphere | ∞ | 2.000 | | | | Refraction | | |
| SA | S23 | | | 0 | | | | | | |

| | |
|---|---|
| Image height | Object height |

| | X | Y | X | Y |
|---|---|---|---|---|
| f1 | 0.000 | −1.782 | 0 | 0 |
| f2 | 0.000 | −8.100 | 0 | −1222 |
| f3 | 0.000 | −14.418 | 0 | −2379 |
| f4 | −8.640 | −1.782 | −1616 | 0 |
| f5 | −8.640 | −8.100 | −1612 | −1255 |
| f6 | −8.640 | −14.418 | −1608 | −2389 |

| | |
|---|---|
| Aperture diameter | Display element size |

| | | | |
|---|---|---|---|
| S11 | 23.435 | Long side | 17.28 |
| Aperture stop | 21.194 | Short side | 10.8 |
| S13 | 24.381 | Display element shift range | −7.182~−9.018 |
| S16 | 26.026 | | |

TABLE 11
Aspherical surface coefficient

| S17 | | S18 | |
|---|---|---|---|
| Conic | 0.00000E+00 | Conic | 0.00000E+00 |
| constant (K) | | constant (K) | |
| Fourth order | −2.97040E−06 | Fourth order | 5.52053E−06 |
| coefficient (A) | | coefficient (A) | |
| Sixth order | 4.21560E−09 | Sixth order | 4.28853E−09 |
| coefficient (B) | | coefficient (B) | |
| Eighth order | 1.45432E−11 | Eighth order | 8.23116E−12 |
| coefficient (C) | | coefficient (C) | |
| Tenth order | −2.31318E−15 | Tenth order | 1.78431E−14 |
| coefficient (D) | | coefficient (D) | |

TABLE 12
XY polynomial surface coefficient

| | X**0 | X**1 | X**2 | X**3 | X**4 | X**5 | X**6 | X**7 | X**8 | X**9 | X**10 |
|---|---|---|---|---|---|---|---|---|---|---|---|
| S1 | | | | | | | | | | | |
| Y**0 | | 0.00000E+00 | 1.40376E−02 | 0.00000E+00 | 1.86385E−06 | 0.00000E+00 | 9.67066E−10 | 0.00000E+00 | −1.65932E−13 | 0.00000E+00 | 7.27482E−16 |
| Y**1 | 2.68401E−02 | 0.00000E+00 | 0.00000E+00 | 0.00000E+00 | 0.00000E+00 | 0.00000E+00 | 0.00000E+00 | 0.00000E+00 | 0.00000E+00 | 0.00000E+00 | |
| Y**2 | 1.63227E−02 | 0.00000E+00 | −4.28029E−06 | 0.00000E+00 | 2.50006E−08 | 0.00000E+00 | −2.87641E−11 | 0.00000E+00 | 1.60201E−14 | | |
| Y**3 | 0.00000E+00 | 0.00000E+00 | 0.00000E+00 | 0.00000E+00 | 0.00000E+00 | 0.00000E+00 | 0.00000E+00 | 0.00000E+00 | | | |
| Y**4 | −6.32432E−06 | 0.00000E+00 | 2.82480E−08 | 0.00000E+00 | −5.06362E−11 | 0.00000E+00 | 3.89634E−14 | | | | |
| Y**5 | 0.00000E+00 | 0.00000E+00 | 0.00000E+00 | 0.00000E+00 | 0.00000E+00 | 0.00000E+00 | | | | | |
| Y**6 | 1.23506E−08 | 0.00000E+00 | −3.01276E−11 | 0.00000E+00 | 3.84435E−14 | | | | | | |
| Y**7 | 0.00000E+00 | 0.00000E+00 | 0.00000E+00 | 0.00000E+00 | | | | | | | |
| Y**8 | −8.21033E−12 | 0.00000E+00 | 1.62351E−14 | | | | | | | | |
| Y**9 | 0.00000E+00 | 0.00000E+00 | | | | | | | | | |
| Y**10 | 3.09075E−15 | | | | | | | | | | |
| S2 | | | | | | | | | | | |
| Y**0 | | 0.00000E+00 | −8.01501E−04 | 0.00000E+00 | 0.00000E+00 | 0.00000E+00 | 0.00000E+00 | 0.00000E+00 | 0.00000E+00 | 0.00000E+00 | 0.00000E+00 |
| Y**1 | 4.58349E−02 | 0.00000E+00 | 0.00000E+00 | 0.00000E+00 | 0.00000E+00 | 0.00000E+00 | 0.00000E+00 | 0.00000E+00 | 0.00000E+00 | 0.00000E+00 | |
| Y**2 | −1.00432E−03 | 0.00000E+00 | 4.72037E−07 | 0.00000E+00 | 0.00000E+00 | 0.00000E+00 | 0.00000E+00 | 0.00000E+00 | 0.00000E+00 | | |
| Y**3 | 0.00000E+00 | 0.00000E+00 | 0.00000E+00 | 0.00000E+00 | 0.00000E+00 | 0.00000E+00 | 0.00000E+00 | 0.00000E+00 | | | |
| Y**4 | 0.00000E+00 | 0.00000E+00 | 0.00000E+00 | 0.00000E+00 | 0.00000E+00 | 0.00000E+00 | 0.00000E+00 | | | | |
| Y**5 | 0.00000E+00 | 0.00000E+00 | 0.00000E+00 | 0.00000E+00 | 0.00000E+00 | 0.00000E+00 | | | | | |
| Y**6 | 0.00000E+00 | 0.00000E+00 | 0.00000E+00 | 0.00000E+00 | 0.00000E+00 | | | | | | |
| Y**7 | 0.00000E+00 | 0.00000E+00 | 0.00000E+00 | 0.00000E+00 | | | | | | | |
| Y**8 | 0.00000E+00 | 0.00000E+00 | 0.00000E+00 | | | | | | | | |
| Y**9 | 0.00000E+00 | 0.00000E+00 | | | | | | | | | |
| Y**10 | 0.00000E+00 | | | | | | | | | | |
| S3 | | | | | | | | | | | |
| Y**0 | | 0.00000E+00 | 9.87386E−03 | 0.00000E+00 | 1.38518E−05 | 0.00000E+00 | −8.58671E−08 | 0.00000E+00 | 1.69886E−10 | 0.00000E+00 | −1.20186E−13 |
| Y**1 | −6.34202E−02 | 0.00000E+00 | 0.00000E+00 | 0.00000E+00 | 0.00000E+00 | 0.00000E+00 | 0.00000E+00 | 0.00000E+00 | 0.00000E+00 | 0.00000E+00 | |
| Y**2 | 1.11282E−02 | 0.00000E+00 | 2.59469E−06 | 0.00000E+00 | −5.16721E−08 | 0.00000E+00 | 1.63559E−10 | 0.00000E+00 | −1.71444E−13 | | |
| Y**3 | 0.00000E+00 | 0.00000E+00 | 0.00000E+00 | 0.00000E+00 | 0.00000E+00 | 0.00000E+00 | 0.00000E+00 | 0.00000E+00 | | | |
| Y**4 | 6.55482E−07 | 0.00000E+00 | −1.41571E−08 | 0.00000E+00 | 2.11563E−11 | 0.00000E+00 | −5.81412E−14 | | | | |
| Y**5 | 0.00000E+00 | 0.00000E+00 | 0.00000E+00 | 0.00000E+00 | 0.00000E+00 | 0.00000E+00 | | | | | |
| Y**6 | −7.49593E−09 | 0.00000E+00 | 2.42916E−12 | 0.00000E+00 | 1.36941E−14 | | | | | | |
| Y**7 | 0.00000E+00 | 0.00000E+00 | 0.00000E+00 | 0.00000E+00 | | | | | | | |
| Y**8 | 5.84112E−12 | 0.00000E+00 | 1.90877E−15 | | | | | | | | |
| Y**9 | 0.00000E+00 | 0.00000E+00 | | | | | | | | | |
| Y**10 | −1.87145E−15 | | | | | | | | | | |
| S4 | | | | | | | | | | | |
| Y**0 | | 0.00000E+00 | 2.03498E−02 | 0.00000E+00 | −1.38338E−04 | 0.00000E+00 | 1.01977E−06 | 0.00000E+00 | −2.62442E−09 | 0.00000E+00 | 2.15000E−12 |
| Y**1 | −2.81558E−01 | 0.00000E+00 | 0.00000E+00 | 0.00000E+00 | 0.00000E+00 | 0.00000E+00 | 0.00000E+00 | 0.00000E+00 | 0.00000E+00 | 0.00000E+00 | |
| Y**2 | 3.34041E−02 | 0.00000E+00 | −4.85643E−05 | 0.00000E+00 | 3.90177E−07 | 0.00000E+00 | −1.74537E−09 | 0.00000E+00 | 2.42802E−12 | | |
| Y**3 | 0.00000E+00 | 0.00000E+00 | 0.00000E+00 | 0.00000E+00 | 0.00000E+00 | 0.00000E+00 | 0.00000E+00 | 0.00000E+00 | | | |
| Y**4 | −2.01886E−05 | 0.00000E+00 | 6.60533E−08 | 0.00000E+00 | −1.47383E−10 | 0.00000E+00 | 2.15847E−13 | | | | |
| Y**5 | 0.00000E+00 | 0.00000E+00 | 0.00000E+00 | 0.00000E+00 | 0.00000E+00 | 0.00000E+00 | | | | | |
| Y**6 | 3.30413E−09 | 0.00000E+00 | −8.63807E−11 | 0.00000E+00 | 1.58892E−13 | | | | | | |
| Y**7 | 0.00000E+00 | 0.00000E+00 | 0.00000E+00 | 0.00000E+00 | | | | | | | |
| Y**8 | 2.07743E−11 | 0.00000E+00 | 6.45909E−14 | | | | | | | | |
| Y**9 | 0.00000E+00 | 0.00000E+00 | | | | | | | | | |
| Y**10 | −1.08988E−14 | | | | | | | | | | |

TABLE 13

| | Surface | | Curvature | | Refractive | Abbe | | Refraction/ | Eccentric | Y |
|---|---|---|---|---|---|---|---|---|---|---|
| | number | Object height | radius | Interval | index | number | Material | Reflection | type | eccentricity |
| SR | S0 | | | 1131 | | | | | | |
| T2 | S1 | XY polynomial | −1350.982 | 18.222 | 1.589 | 61.264 | KSKLD5 | Refraction | DAR | 0.000 |
| | | surface | | | | | | | | |
| R2 | S2 | XY polynomial | 1400.387 | −27.101 | 1.589 | 61.264 | KSKLD5 | Reflection | DAR | 0.000 |
| | | surface | | | | | | | | |
| R1 | S3 | XY polynomial | 116.408 | 30.000 | 1.589 | 61.264 | KSKLD5 | Reflection | DAR | 0.000 |
| | | surface | | | | | | | | |
| T1 | S4 | XY polynomial | −33.957 | 29.993 | | | | Refraction | DAR | 0.000 |
| | | surface | | | | | | | | |
| L7 | S5 | Sphere | −98.261 | 3.000 | 1.847 | 23.784 | FDS90SG | Refraction | | |
| L7 | S6 | Sphere | 1899.348 | 7.268 | | | | Refraction | | |
| L6 | S7 | Sphere | −120.991 | 15.780 | 1.702 | 41.148 | BAFD7 | Refraction | | |
| L6 | S8 | Sphere | −55.581 | 10.000 | | | | Refraction | | |
| L5 | S9 | Sphere | −514.208 | 14.107 | 1.729 | 54.673 | TAC8 | Refraction | | |
| L5 | S10 | Sphere | −81.340 | 71.539 | | | | Refraction | | |
| | S11 | Sphere | ∞ | 15.000 | | | | Refraction | | |
| ST | S12 | Sphere | ∞ | 12.289 | | | | Refraction | | |
| Aperture | | | | | | | | | | |
| stop | | | | | | | | | | |
| L4 | S13 | Sphere | 39.314 | 9.226 | 1.437 | 95.099 | FCD100 | Refraction | | |
| L4 | S14 | Sphere | −34.812 | 2.937 | | | | Refraction | | |
| L3 | S15 | Sphere | −28.242 | 1.500 | 1.673 | 38.255 | SNBH52V | Refraction | | |
| L3 | S16 | Sphere | 78.147 | 10.561 | | | | Refraction | | |
| L2 | S17 | Aspherical | 89.227 | 11.291 | 1.589 | 61.264 | ‘KSKLD5’ | Refraction | | |
| | | surface | | | | | | | | |
| L2 | S18 | Aspherical | −42.016 | 0.399 | | | | Refraction | | |
| | | surface | | | | | | | | |
| L1 | S19 | Sphere | −262.410 | 12.825 | 1.437 | 95.099 | FCD100 | Refraction | | |
| L1 | S20 | Sphere | −33.131 | 13.900 | | | | Refraction | | |
| PA | S21 | Sphere | ∞ | 34.600 | 1.517 | 64.166 | BK7 | Refraction | | |
| PA | S22 | Sphere | ∞ | 2.000 | | | | Refraction | | |
| SA | S23 | | | | | | | | | |

| | |
|---|---|
| Image height | Object height |

| | X | Y | X | Y |
|---|---|---|---|---|
| f1 | 0.000 | −1.782 | 0 | −333 |
| f2 | 0.000 | −8.100 | 0 | −1508 |
| f3 | 0.000 | −14.418 | 0 | −2704 |
| f4 | −8.640 | −1.782 | −1616 | −337 |
| f5 | −8.640 | −8.100 | −1610 | −1521 |
| f6 | −8.640 | −14.418 | −1615 | −2707 |

| | |
|---|---|
| Aperture diameter | Display element size |

| | | | |
|---|---|---|---|
| S11 | 23.435 | Long side | 17.28 |
| Aperture stop | 21.194 | Short side | 10.8 |
| S13 | 24.381 | Display element shift range | −7.182~−9.018 |
| S16 | 26.026 | | |

TABLE 14
Aspherical surface coefficient

| S17 | | S18 | |
|---|---|---|---|
| Conic | 0.00000E+00 | Conic | 0.00000E+00 |
| constant (K) | | constant (K) | |
| Fourth order | −2.97040E−06 | Fourth order | 5.52053E−06 |
| coefficient (A) | | coefficient (A) | |
| Sixth order | 4.21560E−09 | Sixth order | 4.28853E−09 |
| coefficient (B) | | coefficient (B) | |
| Eighth order | 1.45432E−11 | Eighth order | 8.23116E−12 |
| coefficient (C) | | coefficient (C) | |
| Tenth order | −2.31318E−15 | Tenth order | 1.78431E−14 |
| coefficient (D) | | coefficient (D) | |

TABLE 15
XY polynomial surface coefficient

| | X**0 | X**1 | X**2 | X**3 | X**4 | X**5 | X**6 | X**7 | X**8 | X**9 | X**10 |
|---|---|---|---|---|---|---|---|---|---|---|---|
| S1 | | | | | | | | | | | |
| Y**0 | | 0.00000E+00 | 1.19477E−02 | 0.00000E+00 | −1.09711E−06 | 0.00000E+00 | 9.88101E−09 | 0.00000E+00 | −8.00794E−12 | 0.00000E+00 | 3.77658E−15 |
| Y**1 | 0.00000E+00 | 0.00000E+00 | 0.00000E+00 | 0.00000E+00 | 0.00000E+00 | 0.00000E+00 | 0.00000E+00 | 0.00000E+00 | 0.00000E+00 | 0.00000E+00 | |
| Y**2 | 1.14398E−02 | 0.00000E+00 | −3.91553E−06 | 0.00000E+00 | 3.77094E−08 | 0.00000E+00 | −4.76552E−11 | 0.00000E+00 | 3.21978E−14 | | |
| Y**3 | 0.00000E+00 | 0.00000E+00 | 0.00000E+00 | 0.00000E+00 | 0.00000E+00 | 0.00000E+00 | 0.00000E+00 | 0.00000E+00 | | | |
| Y**4 | −1.03433E−06 | 0.00000E+00 | 3.96132E−08 | 0.00000E+00 | −7.79296E−11 | 0.00000E+00 | 6.66121E−14 | | | | |
| Y**5 | 0.00000E+00 | 0.00000E+00 | 0.00000E+00 | 0.00000E+00 | 0.00000E+00 | 0.00000E+00 | | | | | |
| Y**6 | 1.12747E−08 | 0.00000E+00 | −5.32005E−11 | 0.00000E+00 | 7.06961E−14 | | | | | | |
| Y**7 | 0.00000E+00 | 0.00000E+00 | 0.00000E+00 | 0.00000E+00 | | | | | | | |
| Y**8 | −1.12656E−11 | 0.00000E+00 | 3.49489E−14 | | | | | | | | |
| Y**9 | 0.00000E+00 | 0.00000E+00 | | | | | | | | | |
| Y**10 | 6.09375E−15 | | | | | | | | | | |
| S2 | | | | | | | | | | | |
| Y**0 | | 0.00000E+00 | −7.33047E−04 | 0.00000E+00 | 0.00000E+00 | 0.00000E+00 | 0.00000E+00 | 0.00000E+00 | 0.00000E+00 | 0.00000E+00 | 0.00000E+00 |
| Y**1 | 0.00000E+00 | 0.00000E+00 | 0.00000E+00 | 0.00000E+00 | 0.00000E+00 | 0.00000E+00 | 0.00000E+00 | 0.00000E+00 | 0.00000E+00 | 0.00000E+00 | |
| Y**2 | −7.85812E−04 | 0.00000E+00 | 7.82226E−08 | 0.00000E+00 | 0.00000E+00 | 0.00000E+00 | 0.00000E+00 | 0.00000E+00 | 0.00000E+00 | | |
| Y**3 | 0.00000E+00 | 0.00000E+00 | 0.00000E+00 | 0.00000E+00 | 0.00000E+00 | 0.00000E+00 | 0.00000E+00 | 0.00000E+00 | | | |
| Y**4 | 0.00000E+00 | 0.00000E+00 | 0.00000E+00 | 0.00000E+00 | 0.00000E+00 | 0.00000E+00 | 0.00000E+00 | | | | |
| Y**5 | 0.00000E+00 | 0.00000E+00 | 0.00000E+00 | 0.00000E+00 | 0.00000E+00 | 0.00000E+00 | | | | | |
| Y**6 | 0.00000E+00 | 0.00000E+00 | 0.00000E+00 | 0.00000E+00 | 0.00000E+00 | | | | | | |
| Y**7 | 0.00000E+00 | 0.00000E+00 | 0.00000E+00 | 0.00000E+00 | | | | | | | |
| Y**8 | 0.00000E+00 | 0.00000E+00 | 0.00000E+00 | | | | | | | | |
| Y**9 | 0.00000E+00 | 0.00000E+00 | | | | | | | | | |
| Y**10 | 0.00000E+00 | | | | | | | | | | |
| S3 | | | | | | | | | | | |
| Y**0 | | 0.00000E+00 | 9.67952E−03 | 0.00000E+00 | 6.13161E−07 | 0.00000E+00 | −1.88380E−08 | 0.00000E+00 | 3.91512E−11 | 0.00000E+00 | −4.19190E−14 |
| Y**1 | 0.00000E+00 | 0.00000E+00 | 0.00000E+00 | 0.00000E+00 | 0.00000E+00 | 0.00000E+00 | 0.00000E+00 | 0.00000E+00 | 0.00000E+00 | 0.00000E+00 | |
| Y**2 | 1.01561E−02 | 0.00000E+00 | −3.84593E−07 | 0.00000E+00 | −4.35433E−08 | 0.00000E+00 | 7.11824E−11 | 0.00000E+00 | −6.41659E−14 | | |
| Y**3 | 0.00000E+00 | 0.00000E+00 | 0.00000E+00 | 0.00000E+00 | 0.00000E+00 | 0.00000E+00 | 0.00000E+00 | 0.00000E+00 | | | |
| Y**4 | −1.76001E−06 | 0.00000E+00 | −4.45878E−08 | 0.00000E+00 | 1.20848E−10 | 0.00000E+00 | −1.21277E−13 | | | | |
| Y**5 | 0.00000E+00 | 0.00000E+00 | 0.00000E+00 | 0.00000E+00 | 0.00000E+00 | 0.00000E+00 | | | | | |
| Y**6 | −1.06100E−08 | 0.00000E+00 | 7.87854E−11 | 0.00000E+00 | −1.39014E−13 | | | | | | |
| Y**7 | 0.00000E+00 | 0.00000E+00 | 0.00000E+00 | 0.00000E+00 | | | | | | | |
| Y**8 | 1.28129E−11 | 0.00000E+00 | −6.33851E−14 | | | | | | | | |
| Y**9 | 0.00000E+00 | 0.00000E+00 | | | | | | | | | |
| Y**10 | −8.51349E−15 | | | | | | | | | | |
| S4 | | | | | | | | | | | |
| Y**0 | | 0.00000E+00 | 1.71370E−02 | 0.00000E+00 | −2.63846E−05 | 0.00000E+00 | 5.19290E−08 | 0.00000E+00 | −4.95278E−11 | 0.00000E+00 | 4.89246E−15 |
| Y**1 | 0.00000E+00 | 0.00000E+00 | 0.00000E+00 | 0.00000E+00 | 0.00000E+00 | 0.00000E+00 | 0.00000E+00 | 0.00000E+00 | 0.00000E+00 | 0.00000E+00 | |
| Y**2 | 1.78138E−02 | 0.00000E+00 | −5.72362E−05 | 0.00000E+00 | 1.49144E−07 | 0.00000E+00 | −2.11446E−10 | 0.00000E+00 | 1.46044E−13 | | |
| Y**3 | 0.00000E+00 | 0.00000E+00 | 0.00000E+00 | 0.00000E+00 | 0.00000E+00 | 0.00000E+00 | 0.00000E+00 | 0.00000E+00 | | | |
| Y**4 | −2.41295E−05 | 0.00000E+00 | 1.29846E−07 | 0.00000E+00 | −2.15107E−10 | 0.00000E+00 | 1.41626E−13 | | | | |
| Y**5 | 0.00000E+00 | 0.00000E+00 | 0.00000E+00 | 0.00000E+00 | 0.00000E+00 | 0.00000E+00 | | | | | |
| Y**6 | 3.22690E−08 | 0.00000E+00 | −1.29309E−10 | 0.00000E+00 | 1.15520E−13 | | | | | | |
| Y**7 | 0.00000E+00 | 0.00000E+00 | 0.00000E+00 | 0.00000E+00 | | | | | | | |
| Y**8 | −2.14103E−11 | 0.00000E+00 | 5.33421E−14 | | | | | | | | |
| Y**9 | 0.00000E+00 | 0.00000E+00 | | | | | | | | | |
| Y**10 | 6.85186E−15 | | | | | | | | | | |

TABLE 16

| | Surface | | Curvature | | Refractive | Abbe | | Refraction/ | Eccentric | Y |
|---|---|---|---|---|---|---|---|---|---|---|
| | number | Object height | radius | Interval | index | number | Material | Reflection | type | eccentricity |
| SR | S0 | | | 1131 | | | | | | |
| T2 | S1 | XY polynomial | 208.732 | 17.258 | 1.589 | 61.264 | KSKLD5 | Refraction | DAR | −1.238 |
| | | surface | | | | | | | | |
| R2 | S2 | XY polynomial | 334.249 | −25.488 | 1.589 | 61.264 | KSKLD5 | Reflection | DAR | −19.848 |
| | | surface | | | | | | | | |
| R1 | S3 | XY polynomial | 49.057 | 27.862 | 1.589 | 61.264 | KSKLD5 | Reflection | DAR | −15.301 |
| | | surface | | | | | | | | |
| T1 | S4 | XY polynomial | −43.116 | 15.970 | | | | Refraction | DAR | −5.793 |
| | | surface | | | | | | | | |
| L7 | S5 | Sphere | −122.211 | 3.000 | 1.847 | 23.784 | FDS90SG | Refraction | | |
| L7 | S6 | Sphere | 777.948 | 9.172 | | | | Refraction | | |
| L6 | S7 | Sphere | −104.570 | 18.305 | 1.702 | 41.148 | BAFD7 | Refraction | | |
| L6 | S8 | Sphere | −51.966 | 23.156 | | | | Refraction | | |
| L5 | S9 | Sphere | −314.756 | 15.416 | 1.729 | 54.673 | TAC8 | Refraction | | |
| L5 | S10 | Sphere | −75.990 | 70.551 | | | | Refraction | | |
| | S11 | Sphere | ∞ | 15.000 | | | | Refraction | | |
| ST | S12 | Sphere | ∞ | 12.289 | | | | Refraction | | |
| Aperture | | | | | | | | | | |
| stop | | | | | | | | | | |
| L4 | S13 | Sphere | 39.314 | 9.226 | 1.437 | 95.099 | FCD100 | Refraction | | |
| L4 | S14 | Sphere | −34.812 | 2.937 | | | | Refraction | | |
| L3 | S15 | Sphere | −28.242 | 1.500 | 1.673 | 38.255 | SNBH52V | Refraction | | |
| L3 | S16 | Sphere | 78.147 | 10.561 | | | | Refraction | | |
| L2 | S17 | Aspherical | 89.227 | 11.291 | 1.589 | 61.264 | ‘KSKLD5’ | Refraction | | |
| | | surface | | | | | | | | |
| L2 | S18 | Aspherical | −42.016 | 0.399 | | | | Refraction | | |
| | | surface | | | | | | | | |
| L1 | S19 | Sphere | −262.410 | 12.825 | 1.437 | 95.099 | FCD100 | Refraction | | |
| L1 | S20 | Sphere | −33.131 | 13.900 | | | | Refraction | | |
| PA | S21 | Sphere | ∞ | 34.600 | 1.517 | 64.166 | BK7 | Refraction | | |
| PA | S22 | Sphere | ∞ | 2.000 | | | | Refraction | | |
| SA | S23 | | | | | | | | | |

| | |
|---|---|
| Image height | Object height |

| | X | Y | X | Y |
|---|---|---|---|---|
| f1 | 0.000 | −1.782 | 0 | −666 |
| f2 | 0.000 | −8.100 | 0 | −1846 |
| f3 | 0.000 | −14.418 | 0 | −3038 |
| f4 | −8.640 | −1.782 | −1616 | −673 |
| f5 | −8.640 | −8.100 | −1617 | −1841 |
| f6 | −8.640 | −14.418 | −1614 | −3056 |

| | |
|---|---|
| Aperture diameter | Display element size |

| | | | |
|---|---|---|---|
| S11 | 23.435 | Long side | 17.28 |
| Aperture stop | 21.194 | Short side | 10.8 |
| S13 | 24.381 | Display element shift range | −7.182~−9.018 |
| S16 | 26.026 | | |

TABLE 17
Aspherical surface coefficient

| S17 | | S18 | |
|---|---|---|---|
| Conic | 0.00000E+00 | Conic | 0.00000E+00 |
| constant (K) | | constant (K) | |
| Fourth order | −2.97040E−06 | Fourth order | 5.52053E−06 |
| coefficient (A) | | coefficient (A) | |
| Sixth order | 4.21560E−09 | Sixth order | 4.28853E−09 |
| coefficient (B) | | coefficient (B) | |
| Eighth order | 1.45432E−11 | Eighth order | 8.23116E−12 |
| coefficient (C) | | coefficient (C) | |
| Tenth order | −2.31318E−15 | Tenth order | 1.78431E−14 |
| coefficient (D) | | coefficient (D) | |

TABLE 18
XY polynomial surface coefficient

| | X**0 | X**1 | X**2 | X**3 | X**4 | X**5 | X**6 | X**7 | X**8 | X**9 | X**10 |
|---|---|---|---|---|---|---|---|---|---|---|---|
| S1 | | | | | | | | | | | |
| Y**0 | | 0.00000E+00 | 3.63759E−03 | 0.00000E+00 | 7.24438E−06 | 0.00000E+00 | 4.62196E−09 | 0.00000E+00 | 0.00000E+00 | 0.00000E+00 | 0.00000E+00 |
| Y**1 | 6.16957E−01 | 0.00000E+00 | −1.32516E−03 | 0.00000E+00 | 1.31591E−06 | 0.00000E+00 | 1.92461E−11 | 0.00000E+00 | 0.00000E+00 | 0.00000E+00 | |
| Y**2 | 5.63827E−02 | 0.00000E+00 | −9.84795E−05 | 0.00000E+00 | 8.62347E−08 | 0.00000E+00 | −2.54786E−11 | 0.00000E+00 | 0.00000E+00 | | |
| Y**3 | 1.49481E−03 | 0.00000E+00 | −1.89079E−06 | 0.00000E+00 | −1.30806E−10 | 0.00000E+00 | −5.16530E−13 | 0.00000E+00 | | | |
| Y**4 | 4.24651E−06 | 0.00000E+00 | 5.37511E−08 | 0.00000E+00 | −9.59539E−11 | 0.00000E+00 | 1.93980E−14 | | | | |
| Y**5 | −2.32493E−07 | 0.00000E+00 | 9.84845E−11 | 0.00000E+00 | 2.87775E−13 | 0.00000E+00 | | | | | |
| Y**6 | 1.92481E−08 | 0.00000E+00 | −7.42886E−11 | 0.00000E+00 | 6.28246E−14 | | | | | | |
| Y**7 | 5.58656E−12 | 0.00000E+00 | −1.34651E−13 | 0.00000E+00 | | | | | | | |
| Y**8 | −1.93690E−11 | 0.00000E+00 | 3.04924E−14 | | | | | | | | |
| Y**9 | 1.77736E−15 | 0.00000E+00 | | | | | | | | | |
| Y**10 | 6.89638E−15 | | | | | | | | | | |
| S2 | | | | | | | | | | | |
| Y**0 | | 0.00000E+00 | −1.90415E−03 | 0.00000E+00 | −1.03904E−06 | 0.00000E+00 | 0.00000E+00 | 0.00000E+00 | 0.00000E+00 | 0.00000E+00 | 0.00000E+00 |
| Y**1 | −9.02833E−03 | 0.00000E+00 | −5.86052E−05 | 0.00000E+00 | −3.15755E−08 | 0.00000E+00 | 0.00000E+00 | 0.00000E+00 | 0.00000E+00 | 0.00000E+00 | |
| Y**2 | −1.75410E−03 | 0.00000E+00 | 1.02509E−05 | 0.00000E+00 | 3.03769E−08 | 0.00000E+00 | 0.00000E+00 | 0.00000E+00 | 0.00000E+00 | | |
| Y**3 | −7.62818E−06 | 0.00000E+00 | −1.64370E−06 | 0.00000E+00 | −2.63595E−09 | 0.00000E+00 | 0.00000E+00 | 0.00000E+00 | | | |
| Y**4 | −7.32083E−07 | 0.00000E+00 | 1.50958E−07 | 0.00000E+00 | −1.57413E−10 | 0.00000E+00 | 0.00000E+00 | | | | |
| Y**5 | 3.49806E−09 | 0.00000E+00 | −7.38150E−09 | 0.00000E+00 | 2.58599E−11 | 0.00000E+00 | | | | | |
| Y**6 | 2.83743E−09 | 0.00000E+00 | 1.84382E−10 | 0.00000E+00 | −7.07205E−13 | | | | | | |
| Y**7 | −5.80354E−11 | 0.00000E+00 | −3.42641E−12 | 0.00000E+00 | | | | | | | |
| Y**8 | −1.30372E−12 | 0.00000E+00 | 9.21081E−14 | | | | | | | | |
| Y**9 | −1.13440E−13 | 0.00000E+00 | | | | | | | | | |
| Y**10 | 5.37125E−15 | | | | | | | | | | |
| S3 | | | | | | | | | | | |
| Y**0 | | 0.00000E+00 | 7.46960E−03 | 0.00000E+00 | −1.19869E−05 | 0.00000E+00 | −6.18875E−08 | 0.00000E+00 | 1.03224E−10 | 0.00000E+00 | −3.20719E−15 |
| Y**1 | −9.66513E−01 | 0.00000E+00 | −6.10855E−05 | 0.00000E+00 | 1.91296E−06 | 0.00000E+00 | 3.59881E−09 | 0.00000E+00 | −7.19434E−12 | 0.00000E+00 | |
| Y**2 | 6.60041E−02 | 0.00000E+00 | −3.03122E−05 | 0.00000E+00 | −7.19123E−08 | 0.00000E+00 | −5.24817E−11 | 0.00000E+00 | 1.25919E−13 | | |
| Y**3 | −2.55295E−03 | 0.00000E+00 | 1.42809E−06 | 0.00000E+00 | −7.08555E−10 | 0.00000E+00 | 4.54227E−13 | 0.00000E+00 | | | |
| Y**4 | 3.54812E−05 | 0.00000E+00 | −1.86492E−08 | 0.00000E+00 | 5.56270E−11 | 0.00000E+00 | −2.01960E−14 | | | | |
| Y**5 | 3.11157E−07 | 0.00000E+00 | −6.17236E−11 | 0.00000E+00 | −1.19430E−13 | 0.00000E+00 | | | | | |
| Y**6 | −1.14347E−08 | 0.00000E+00 | −3.16079E−12 | 0.00000E+00 | −1.25093E−14 | | | | | | |
| Y**7 | 1.34648E−11 | 0.00000E+00 | 5.93739E−14 | 0.00000E+00 | | | | | | | |
| Y**8 | 1.97329E−13 | 0.00000E+00 | −5.88263E−16 | | | | | | | | |
| Y**9 | 3.05462E−15 | 0.00000E+00 | | | | | | | | | |
| Y**10 | 4.40930E−17 | | | | | | | | | | |
| S4 | | | | | | | | | | | |
| Y**0 | | 0.00000E+00 | 4.36442E−02 | 0.00000E+00 | −1.02944E−04 | 0.00000E+00 | 1.28062E−07 | 0.00000E+00 | 0.00000E+00 | 0.00000E+00 | 0.00000E+00 |
| Y**1 | 9.87034E−01 | 0.00000E+00 | −1.86234E−03 | 0.00000E+00 | 1.06512E−05 | 0.00000E+00 | −1.29879E−08 | 0.00000E+00 | 0.00000E+00 | 0.00000E+00 | |
| Y**2 | 1.57522E−01 | 0.00000E+00 | −3.08072E−05 | 0.00000E+00 | −4.12931E−07 | 0.00000E+00 | 3.02223E−10 | 0.00000E+00 | 0.00000E+00 | | |
| Y**3 | −9.94031E−03 | 0.00000E+00 | 6.07723E−06 | 0.00000E+00 | 5.34511E−09 | 0.00000E+00 | 3.81454E−12 | 0.00000E+00 | | | |
| Y**4 | 2.53596E−04 | 0.00000E+00 | −8.33006E−08 | 0.00000E+00 | 7.84892E−11 | 0.00000E+00 | −1.58495E−13 | | | | |
| Y**5 | 3.35160E−06 | 0.00000E+00 | −9.98592E−09 | 0.00000E+00 | −1.24280E−12 | 0.00000E+00 | | | | | |
| Y**6 | −2.38288E−07 | 0.00000E+00 | 3.27815E−10 | 0.00000E+00 | −2.02073E−14 | | | | | | |
| Y**7 | −1.57225E−10 | 0.00000E+00 | −7.15380E−14 | 0.00000E+00 | | | | | | | |
| Y**8 | 9.78514E−11 | 0.00000E+00 | −6.27602E−14 | | | | | | | | |
| Y**9 | 5.73216E−14 | 0.00000E+00 | | | | | | | | | |
| Y**10 | −2.03739E−14 | | | | | | | | | | |

Table 19 below illustrates the total focal length fa of the rotationally symmetric lens in each of the first to second numerical examples and the corresponding value of the formula (1). In a case where a large screen image perpendicular to the optical axis OA is projected in an oblique direction toward the screen, the image forming element is also often shifted in the Y direction from the optical axis OA as necessary. Here, a case where the shift amount of the image forming element in the Y direction is −7.182 mm and −9.018 mm will be exemplified. That is, in FIG. 2, the center position of the original image SA of the image forming element is shifted downward by 7.182 mm and 9.018 mm with respect to the optical axis OA.

TABLE 19

| | | Example 1 | | | Example 2 | | |
|---|---|---|---|---|---|---|---|
| Conditions | | (A) | (B) | (C) | (A) | (B) | (C) |
| fa | Focal length of entire rotationally | 92.5678 | 167.833 | 207.371 | 65.0397 | 114.668 | 170.424 |
| | symmetric lens system | | | | | | |
| | Entire rotationally symmetric system | 0.644 | 1.168 | 1.443 | 1.471 | 2.593 | 3.854 |
| | fa/base optical system fb | | | | | | |
| | An angle αi2m at which a main light ray of | 6.1 | 12.1 | 23.7 | 4.3 | 13.1 | 24.6 |
| | a light flux closest to an optical axis is | | | | | | |
| | incident on the second reflection surface | | | | | | |
| Image forming | H | 3214 | 3249 | 3249 | 3225 | 3216 | 3231 |
| element shift | D | 1131 | 1131 | 1131 | 1131 | 1131 | 1131 |
| amount −7.182 mm | V | 2004 | 2022 | 2022 | 2035 | 2011 | 2015 |
| | S | −1017 | −1672 | −1672 | −1058 | −1344 | −1658 |
| | \|(S × H)/(V × D)\| . . . (1) | 1.44 | 2.38 | 2.38 | 1.48 | 1.90 | 2.35 |
| | Horizontal angle of view | 108.6 | 109.7 | 109.7 | 108.3 | 108.8 | 109.2 |
| Image forming | H | 3219 | 3248 | 3248 | 3224 | 3223 | 3232 |
| element shift | D | 1131 | 1131 | 1131 | 1131 | 1131 | 1131 |
| amount −9.018 mm | V | 2016 | 2042 | 2042 | 2014 | 2020 | 2076 |
| | S | −1350 | −2011 | −2011 | −1384 | −1674 | −2027 |
| | \|(S × H)/(V × D)\| | 1.91 | 2.83 | 2.83 | 1.96 | 2.36 | 2.79 |
| | Horizontal angle of view | 108.7 | 109.7 | 109.7 | 108.3 | 109.0 | 109.2 |
| | Focal length fb of base optical system | 143.67 | 143.67 | 143.67 | 44.2215 | 44.2215 | 44.2215 |

### Second Embodiment

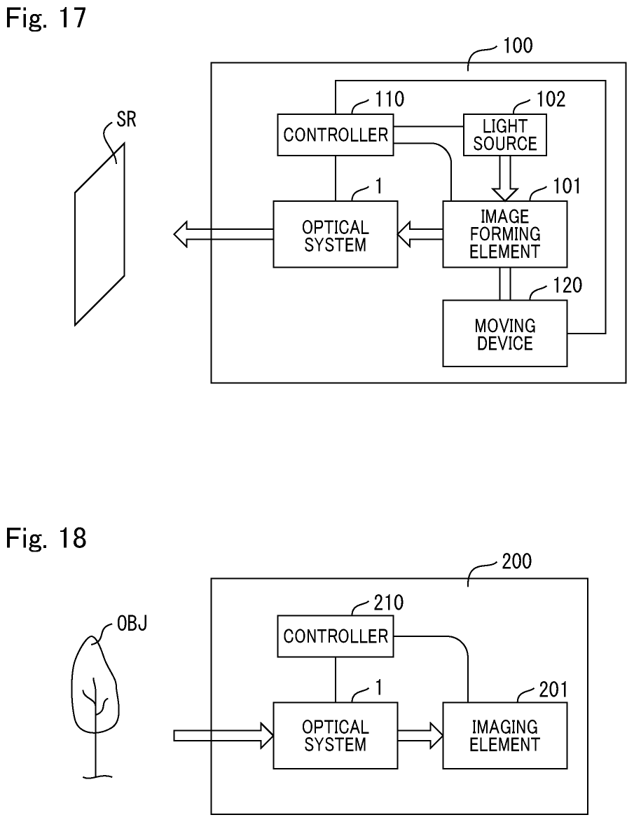

Hereinafter, a second embodiment of the present disclosure will be described with reference to FIG. 17. FIG. 17 is a block diagram illustrating an example of an image projection apparatus according to the present disclosure. The image projection apparatus 100 includes the optical system 1 disclosed in the first embodiment, an image forming element 101, a light source 102, a controller 110, and a moving device 120. The image forming element 101 includes a liquid crystal, a DMD, and the like, and generates an image to be projected onto the screen SR via the optical system 1. The light source 102 includes a light emitting diode (LED), a laser, and the like, and supplies light to the image forming element 101. The controller 110 includes a CPU, an MPU, and the like, and controls the entire device and each component. The optical system 1 may be configured as an interchangeable lens detachably attachable to the image projection apparatus 100, or may be configured as a built-in lens integrated with the image projection apparatus 100.

The moving device 120 moves and positions the image forming element 101 between a plurality of positions along a direction perpendicular to the optical axis of the optical system 1 according to a command from the controller 110.

The image projection apparatus according to the present embodiment includes the optical system according to the first embodiment and the image forming element that generates an image to be projected onto a screen via the optical system.

According to such a configuration, it is possible to perform a short-focus and a large screen projection perpendicular to the optical axis in an oblique direction with a small device.

The image projection apparatus 100 according to the present embodiment further includes the moving device 120 that moves the position of the image forming element 101 between a first position along the vertical direction and a second position farther from the optical axis than the first position.

In a case where the first attachment optical system 11 is attached to the base optical system 10, when the position of the image forming element 101 is moved from the first position to the second position by the moving device 120, the vertical distance may be changed from a first distance to a second distance larger than the first distance.

In a case where the second attachment optical system 12 is attached to the base optical system 10, when the position of the image forming element 101 is moved from the first position to the second position by the moving device 120, the vertical distance may be changed from a third distance to a fourth distance larger than the third distance.

The third distance may be larger than the first distance, and the fourth distance may be larger than the second distance.

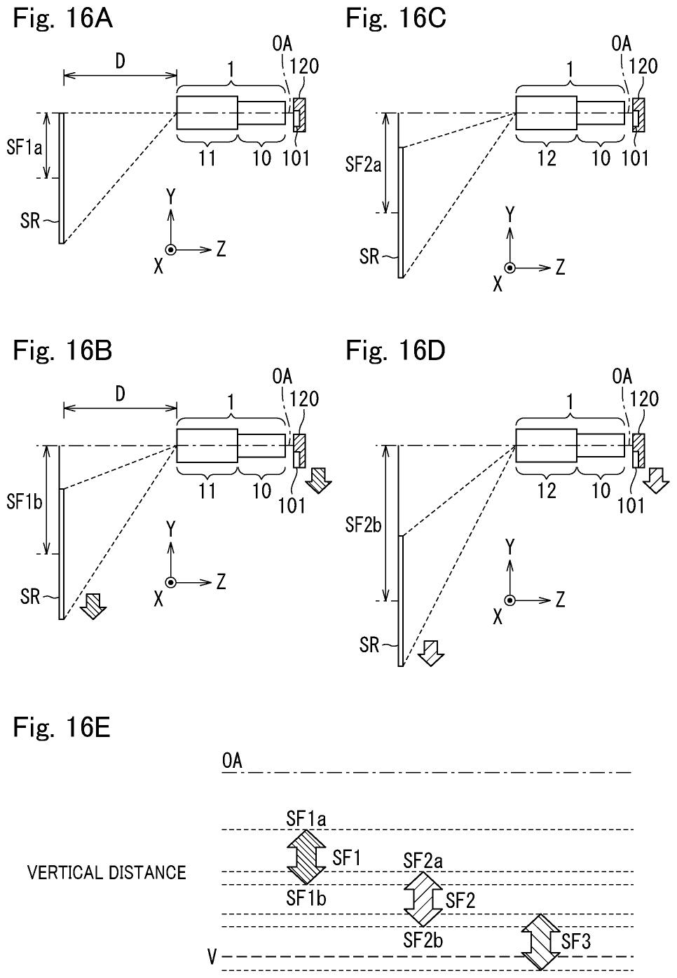

FIGS. 16A to 16E are explanatory diagrams illustrating a relationship between a vertical position of the image forming element 101 and a vertical position of an effective area on which the total light ray is projected on the screen SR. In FIG. 16A, the first attachment optical system 11 is attached to the base optical system 10, and the image forming element 101 is positioned at the first position by the moving device 120. At this time, the vertical distance SF from the optical axis OA to the center of the length of the effective area in the first direction is set to an SF1a (corresponding to the first distance). In FIG. 16B, the first attachment optical system 11 is attached to the base optical system 10, and the image forming element 101 is positioned at the second position farther from the optical axis OA than the first position by the moving device 120. At this time, the vertical distance SF of the effective area is set to an SF1b (corresponding to the second distance) larger than the SF1a (SF1a<SF1b).

In FIG. 16C, the second attachment optical system 12 is attached to the base optical system 10, and the image forming element 101 is positioned at the first position by the moving device 120. At this time, the vertical distance SF of the effective area is set to an SF2a (corresponding to the third distance). In FIG. 16D, the second attachment optical system 12 is attached to the base optical system 10, and the image forming element 101 is positioned at the second position farther from the optical axis OA than the first position by the moving device 120. At this time, the vertical distance SF of the effective area is set to an SF2b (corresponding to the fourth distance) larger than the SF2a (SF2a<SF2b).

Furthermore, the SF2a (third distance) may be set to be larger than the SF1a (first distance), and the SF2b (fourth distance) may be set to be larger than the SF1b (second distance). According to such a configuration, the vertical distance of the projection range can be continuously changed, and as a result, the degree of freedom in arrangement design of the screen and the image projection apparatus is increased.

In the image projection apparatus according to the present embodiment, the third distance may be smaller than the second distance, and
a range in which the vertical distance is changed in a case where the first attachment optical system is attached to the optical system and a range in which the vertical distance is changed in a case where the second attachment optical system is attached to the optical system may partially overlap with each other.

For example, as illustrated in FIG. 16E, in a case where the first attachment optical system 11 is attached to the base optical system 10, the vertical distance SF1 of the effective area can be adjusted over the range of the SF1a to the SF1b by adjusting the position of the image forming element 101. In addition, in a case where the second attachment optical system 12 is attached to the base optical system 10, the vertical distance SF2 of the effective area can be adjusted over the range of the SF2a to the SF2b by adjusting the position of the image forming element 101. In addition, the SF2a (third distance) may be set to be smaller than the SF1b (second distance). In addition, in a case where the third attachment optical system 13 is attached to the base optical system 10, the vertical distance SF3 of the effective area can be adjusted over the range of the SF3a to the SF3b by adjusting the position of the image forming element 101. In addition, the SF3a may be set to be smaller than the SF2b (fourth distance). According to such a configuration, the vertical distance of the projection range can be continuously changed, and as a result, the degree of freedom in arrangement design of the screen and the image projection apparatus is increased.

The image projection apparatus according to the present embodiment may include n (n=an integer of 2 or more) attachment optical systems, a range in which the vertical distance is changed in a case where a k-th (k=an integer of 1 to n−1) attachment optical system is used may partially overlap a range in which the vertical distance is changed in a case where a (k+1)-th attachment optical system is used, and
the vertical distance when the nth attachment optical system is used may be equal to or longer than a length in a first direction parallel to the vertical direction of the projected image.

For example, as illustrated in FIG. 16E, in a case where the third attachment optical system 13 is attached to the base optical system 10, the vertical distance SF3 of the effective area can be set to be larger than a length V of the effective area in the first direction by adjusting the position of the image forming element 101. According to such a configuration, the vertical distance of the projected image can be increased, and as a result, the degree of freedom in arrangement design of the screen and the image projection apparatus is increased. In addition, the image projection apparatus can be, for example, installed in the attic and can obliquely project, and the image projection apparatus can be made less likely to enter the field of view of the audience. In FIG. 16E, the vertical distance SF3 when the third attachment optical system 13 is used is larger than the length V in the first direction parallel to the vertical direction of the projected image, but the vertical distance SF2 when the second attachment optical system 12 is used or the vertical distance when the fourth to nth attachment optical systems are used may be larger than the length V in the first direction parallel to the vertical direction of the projected image.

In the image projection apparatus according to the present embodiment, a change in a half angle of view in the horizontal direction of light projected from the image forming element due to replacement of the first attachment optical system and the second attachment optical system may be 2 degrees or less.

According to such a configuration, even if the attachment optical systems are replaced, the horizontal projection range does not change much, so that good image projection can be performed.

In the image projection apparatus according to the present embodiment, the optical system may be disposed between a display surface of an image forming element disposed at the reduction conjugate point and a screen that is disposed at the magnification conjugate point and on which an image is projected, and the display surface and the screen may be parallel to each other.

### Third Embodiment

Hereinafter, a third embodiment of the present disclosure will be described with reference to FIG. 18. FIG. 18 is a block diagram illustrating an example of an imaging apparatus according to the present disclosure. An imaging apparatus 200 includes the optical system 1 disclosed in the first embodiment, an imaging element 201, a controller 210, and the like. The imaging element 201 includes a charge-coupled element (CCD) image sensor, a CMOS image sensor, and the like, and receives an optical image of an object OBJ formed by the optical system 1 and converts the optical image into an electrical image signal. The controller 110 includes a CPU, an MPU, and the like, and controls the entire apparatus and each component. The optical system 1 may be configured as an interchangeable lens detachably attachable to the imaging apparatus 200, or may be configured as a built-in lens integrated with the imaging apparatus 200.

In the imaging apparatus 200 described above, the optical system 1 according to the first embodiment enables a short-focus and a large screen imaging perpendicular to the optical axis in an oblique direction with a small device.

As described above, the embodiments have been described as disclosures of the technology in the present disclosure. For this purpose, the accompanying drawings and the detailed description have been provided.

Therefore, the components described in the accompanying drawings and the detailed description may include not only components essential for solving the problem but also components that are not essential for solving the problem in order to exemplify the above technology. Therefore, it should not be immediately recognized that these non-essential components are essential on the basis of the fact that these non-essential components are described in the accompanying drawings and the detailed description.

In addition, since the above-described embodiments are intended to exemplify the technology in the present disclosure, various changes, replacements, additions, omissions, and the like can be made within the scope of the claims and equivalents thereof.

What is claimed is:

1. An optical system having a reduction conjugate point on a reduction side and a magnification conjugate point on a magnification side, the optical system comprising:
a base optical system having a plurality of lenses rotationally symmetric with respect to an optical axis and an aperture stop;
a first attachment optical system including a first reflection surface group, and having a first optical characteristic; and
a second attachment optical system including a second reflection surface group, and having a second optical characteristic different from the first optical characteristic, wherein
the base optical system is configured to allow either the first attachment optical system or the second optical system to be attached at a position closer to a magnification side than the base optical system,
in a case where the first attachment optical system is attached to the base optical system, a vertical distance from the optical axis to the magnification conjugate point in a vertical direction to the magnification conjugate point perpendicular to the optical axis is set to a first shift amount, and
in a case where the second attachment optical system is attached to the base optical system, the vertical distance is set to a second shift amount different from the first shift amount.

2. The optical system according to claim 1, wherein an intermediate imaging position that is conjugate with each of the magnification conjugate point and the reduction conjugate point is provided on an optical path of the first attachment optical system attached to the base optical system or the second attachment optical system attached to the base optical system.

3. The optical system according to claim 2, wherein
the first attachment optical system includes a first prism having the first reflection surface group,
the second attachment optical system includes a second prism having the second reflection surface group, and
the intermediate imaging position is provided on an optical path inside the first prism or the second prism.

4. The optical system according to claim 3, wherein the first prism or the second prism includes a first transmission surface, a first reflection surface, a second reflection surface, and a second transmission surface in order from the reduction side to the magnification side, and the intermediate imaging position is provided between the first transmission surface and the first reflection surface.

5. The optical system according to claim 1, wherein when an entire focal length of all rotationally symmetric lenses included in the base optical system and each attachment optical system increases due to replacement of the first attachment optical system and the second attachment optical system, the vertical distance increases.

6. The optical system according to claim 4, wherein when an incident angle at which a main light ray of a light flux closest to the optical axis enters the second reflection surface increases due to replacement of the first attachment optical system and the second attachment optical system, the vertical distance increases.

7. The optical system according to claim 4, wherein the first reflection surface has positive power.

8. The optical system according to claim 4, wherein the first reflection surface has stronger positive power than the second reflection surface.

9. The optical system according to claim 1, satisfying the following formula (1):
$$\vert ( SF / V ) \times ( H / D ) \vert > 2. 7 \qquad ( 1 )$$
wherein,
D is a distance between the magnification conjugate point and the optical system,
V is a length in a first direction parallel to the vertical direction perpendicular to the magnification conjugate point perpendicular to the optical axis, of an effective area on which a total light ray is projected or imaged in a conjugate surface including the magnification conjugate point,
H is a length in a second direction perpendicular to the vertical direction of the effective area on which a total light ray is projected or imaged in a conjugate surface including the magnification conjugate point, and
SF is a shift amount from the optical axis to a center of a vertical range of the effective area.

10. An image projection apparatus comprising:
the optical system according to claim 1; and
an image forming element configured to generate an image to be projected onto a screen via the optical system.

11. The image projection apparatus according to claim 10 further comprising a moving device configured to move a position of the image forming element between a first position along the vertical direction and a second position farther from the optical axis than the first position, wherein
in a case where the first attachment optical system is attached to the base optical system, when a position of the image forming element is moved from the first position to the second position by the moving device, the vertical distance is changed from a first distance to a second distance larger than the first distance,
in a case where the second attachment optical system is attached to the base optical system, when a position of the image forming element is moved from the first position to the second position by the moving device, the vertical distance is changed from a third distance to a fourth distance larger than the third distance, and
the third distance is larger than the first distance, and the fourth distance is larger than the second distance.

12. The image projection apparatus according to claim 11, wherein
the third distance is smaller than the second distance, and
a range in which the vertical distance is changed in a case where the first attachment optical system is attached to the optical system and a range in which the vertical distance is changed in a case where the second attachment optical system is attached to the optical system partially overlap with each other.

13. The image projection apparatus according to claim 12 comprising n (n=an integer of 2 or more) attachment optical systems, wherein
a range in which the vertical distance is changed in a case where a k-th (k=an integer of 1 to n−1) attachment optical system is used and a range in which the vertical distance is changed in a case where a (k+1)-th attachment optical system is used partially overlap with each other, and
the vertical distance when a n-th attachment optical system is used is equal to or longer than a length in a first direction parallel to the vertical direction of a projected image.

14. The image projection apparatus according to claim 10, wherein a change in a half angle of view in a horizontal direction of light projected from the image forming element due to replacement of the first attachment optical system and the second attachment optical system is 2 degrees or less.

15. The image projection apparatus according to claim 10, wherein the optical system is disposed between a display surface of the image forming element disposed at the reduction conjugate point and a screen that is disposed at the magnification conjugate point and on which an image is projected, and the display surface and the screen are parallel to each other.

16. An imaging apparatus comprising:
the optical system according to claim 1; and
an imaging element configured to receive an optical image formed by the optical system and convert the optical image into an electrical image signal.

17. An optical system having a reduction conjugate point on a reduction side and a magnification conjugate point on a magnification side, the optical system comprising:
a base optical system having a plurality of lenses rotationally symmetric with respect to an optical axis and an aperture stop; and
an attachment optical system disposed closer to a magnification side than the base optical system, including a reflection surface group, wherein
in a case where the attachment optical system is a first attachment optical system including a first reflection surface group, and having a first optical characteristic, a vertical distance from the optical axis to the magnification conjugate point in a vertical direction to the magnification conjugate point perpendicular to the optical axis is set to a first shift amount, and
in a case where the attachment optical system is a second attachment optical system including a second reflection surface group, and having a second optical characteristic different from the first optical characteristic, the vertical distance is set to a second shift amount different from the first shift amount.

18. An optical system having a reduction conjugate point on a reduction side and a magnification conjugate point on a magnification side, the optical system comprising:
a base optical system having a plurality of lenses rotationally symmetric with respect to an optical axis and an aperture stop, wherein
the base optical system is configured to allow either a first attachment optical system or a second optical system to be attached at a position closer to a magnification side than the base optical system,
the first attachment optical system includes a first reflection surface group, and has a first optical characteristic,
the second attachment optical system includes a second reflection surface group, and has a second optical characteristic different from the first optical characteristic,
in a case where the first attachment optical system is attached to the base optical system, a vertical distance from the optical axis to the magnification conjugate point in a vertical direction to the magnification conjugate point perpendicular to the optical axis is set to a first shift amount, and
in a case where the second attachment optical system is attached to the base optical system, the vertical distance is set to a second shift amount different from the first shift amount.
